(19) United States
(12) Patent Application Publication
(10) Pub. No.: US 2026/0330357 A1
(43) Pub. Date: Oct. 22, 2026

(54) SYSTEMS, APPARATUSES, METHODS, AND COMPUTER PROGRAM PRODUCTS FOR REAL-TIME PROJECT SERVICES OPERATIONS

(71) Applicant: Honeywell International Inc., Charlotte, NC (US)

(72) Inventors: Honey RAGHAVAN, Bangalore (IN); Anil PALLAYIL, Charlotte, NC (US); Rahul SHARMA, Houston, TX (US)

(21) Appl. No.: 19/650,544

(22) Filed: Apr. 17, 2026

Related U.S. Application Data
(60) Provisional application No. 63/790,885, filed on Apr. 18, 2025.

(51) Int. Cl. G06Q 10/0631

(52) U.S. Cl. CPC G06Q 10/06315

(57) ABSTRACT

Systems, apparatuses, methods, and computer program products are provided herein. For example, a method may include accessing, at a project orchestration predictive computing entity, a requirement electronic record, wherein the requirement electronic record comprises a requirement feature, generating, using a project operations predictive computing entity, a responsive resource allocation unit by applying the requirement feature to a project implementation model, extracting, using the project operations predictive computing entity, a set of free resource unit objects from a plurality of resource unit objects based on the responsive resource allocation unit, generating, using the project operations predictive computing entity, a project implementation electronic record by applying the set of free resource unit objects to the project implementation model, and performing, using the project orchestration predictive computing entity, one or more project implementation actions based on the project implementation electronic record.

### CROSS-REFERENCE TO RELATED APPLICATIONS

This nonprovisional application claims the benefit of priority to U.S. Provisional Patent Application No. 63/790,885, filed Apr. 18, 2025, entitled “SYSTEMS, APPARATUSES, METHODS, AND COMPUTER PROGRAM PRODUCTS FOR REAL-TIME PROJECT SERVICES OPERATIONS,” the entire contents of which are hereby incorporated by reference for all purposes pursuant to 35 U.S.C. § 119(e).

### TECHNOLOGICAL FIELD

Embodiments of the present disclosure relate generally to systems, apparatuses, methods, and computer program products for real-time project services operations.

### BACKGROUND

Applicant has identified many technical challenges and difficulties associated with systems, apparatuses, methods, and computer program products for real-time project services operations. Through applied effort, ingenuity, and innovation, Applicant has solved problems related to systems, apparatuses, methods, and computer program products for real-time project services operations by developing solutions embodied in the present disclosure, which are described in detail below.

### BRIEF SUMMARY

Various embodiments described herein relate to systems, apparatuses, methods, and computer program products for real-time project services operations.

In accordance with one aspect of the disclosure a method is provided. In some embodiments, the method comprises accessing, at a project orchestration predictive computing entity, a requirement electronic record. In some embodiments, the requirement electronic record comprises a requirement feature. In some embodiments, the method comprises generating, using a project operations predictive computing entity, a responsive resource allocation unit by applying the requirement feature to a project implementation model. In some embodiments, the method comprises extracting, using the project operations predictive computing entity, a set of free resource unit objects from a plurality of resource unit objects based on the responsive resource allocation unit. In some embodiments, the method comprises generating, using the project operations predictive computing entity, a project implementation electronic record by applying the set of free resource unit objects to the project implementation model. In some embodiments, the method comprises performing, using the project orchestration predictive computing entity, one or more project implementation actions based on the project implementation electronic record.

In some embodiments, the method comprises determining, using the project implementation model, a physical component object corresponding to the requirement feature. In some embodiments, the method comprises determining, using the project implementation model, a physical component implementation unit based on the physical component object.

In some embodiments, the method comprises training the project implementation model based on an archived requirement feature and an archived responsive resource allocation unit.

In some embodiments, the method comprises generating a project implementation electronic record interface component. In some embodiments, the project implementation electronic record interface component comprises a project implementation electronic record representation. In some embodiments, the method comprises causing rendering of the project implementation electronic record interface component to a project implementation electronic record interface.

In some embodiments, the method comprises executing one or more project implementation computing scripts.

In some embodiments, the method comprises identifying a project implementation impact event associated with the project implementation electronic record. In some embodiments, the method comprises generating a reconfigured project implementation electronic record based on the project implementation impact event. In some embodiments, the method comprises performing one or more reconfigured project implementation actions based on the reconfigured project implementation electronic record.

In some embodiments, identifying the project implementation impact event comprises receiving the project implementation impact event from an external project application device or a project foundation device.

In some embodiments, at least one of the one or more project implementation actions is performed prior to identifying the project implementation impact event.

In some embodiments, the method comprises generating a reconfigured project implementation electronic record interface component. In some embodiments, the reconfigured project implementation electronic record interface component comprises a reconfigured project implementation electronic record representation. In some embodiments, the method comprises causing rendering of the reconfigured project implementation electronic record interface component to a project implementation electronic record interface.

In some embodiments, the method comprises executing one or more project implementation computing scripts.

In accordance with another aspect of the disclosure, an apparatus is provided. In some embodiments, the apparatus includes memory and one or more processors communicatively coupled to the memory. In some embodiments, the one or more processors are configured to perform operations comprising accessing, at a project orchestration predictive computing entity, a requirement electronic record. In some embodiments, the requirement electronic record comprises a requirement feature. In some embodiments, the one or more processors are configured to perform operations comprising generating, using a project operations predictive computing entity, a responsive resource allocation unit by applying the requirement feature to a project implementation model. In some embodiments, the one or more processors are configured to perform operations comprising extracting, using the project operations predictive computing entity, a set of free resource unit objects from a plurality of resource unit objects based on the responsive resource allocation unit. In some embodiments, the one or more processors are configured to perform operations comprising generating, using the project operations predictive computing entity, a project implementation electronic record by applying the set of free resource unit objects to the project implementation model. In some embodiments, the one or more processors are configured to perform operations comprising performing, using the project orchestration predictive computing entity, one or more project implementation actions based on the project implementation electronic record.

In some embodiments, the one or more processors are configured to perform operations comprising determining, using the project implementation model, a physical component object corresponding to the requirement feature. In some embodiments, the one or more processors are configured to perform operations comprising determining, using the project implementation model, a physical component implementation unit based on the physical component object.

In some embodiments, the one or more processors are configured to perform operations comprising training the project implementation model based on an archived requirement feature and an archived responsive resource allocation unit.

In some embodiments, the one or more processors are configured to perform operations comprising generating a project implementation electronic record interface component. In some embodiments, the project implementation electronic record interface component comprises a project implementation electronic record representation. In some embodiments, the one or more processors are configured to perform operations comprising causing rendering of the project implementation electronic record interface component to a project implementation electronic record interface.

In some embodiments, the one or more processors are configured to perform operations comprising executing one or more project implementation computing scripts.

In some embodiments, the one or more processors are configured to perform operations comprising identifying a project implementation impact event associated with the project implementation electronic record. In some embodiments, the one or more processors are configured to perform operations comprising generating a reconfigured project implementation electronic record based on the project implementation impact event. In some embodiments, the one or more processors are configured to perform operations comprising performing one or more reconfigured project implementation actions based on the reconfigured project implementation electronic record.

In some embodiments, identifying the project implementation impact event comprises receiving the project implementation impact event from an external project application device or a project foundation device.

In some embodiments, at least one of the one or more project implementation actions is performed prior to identifying the project implementation impact event.

In some embodiments, the one or more processors are configured to perform operations comprising generating a reconfigured project implementation electronic record interface component. In some embodiments, the reconfigured project implementation electronic record interface component comprises a reconfigured project implementation electronic record representation. In some embodiments, the one or more processors are configured to perform operations comprising causing rendering of the reconfigured project implementation electronic record interface component to a project implementation electronic record interface.

In some embodiments, the one or more processors are configured to perform operations comprising executing one or more project implementation computing scripts.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for accessing, at a project orchestration predictive computing entity, a requirement electronic record. In some embodiments, the requirement electronic record comprises a requirement feature. In some embodiments, the computer program code, in execution with at least one processor, configures the computer program product for generating, using a project operations predictive computing entity, a responsive resource allocation unit by applying the requirement feature to a project implementation model. In some embodiments, the computer program code, in execution with at least one processor, configures the computer program product for extracting, using the project operations predictive computing entity, a set of free resource unit objects from a plurality of resource unit objects based on the responsive resource allocation unit. In some embodiments, the computer program code, in execution with at least one processor, configures the computer program product for generating, using the project operations predictive computing entity, a project implementation electronic record by applying the set of free resource unit objects to the project implementation model. In some embodiments, the computer program code, in execution with at least one processor, configures the computer program product for performing, using the project orchestration predictive computing entity, one or more project implementation actions based on the project implementation electronic record.

In some embodiments, the computer program code, in execution with at least one processor, configures the computer program product for determining, using the project implementation model, a physical component object corresponding to the requirement feature. In some embodiments, the computer program code, in execution with at least one processor, configures the computer program product for determining, using the project implementation model, a physical component implementation unit based on the physical component object.

In some embodiments, the computer program code, in execution with at least one processor, configures the computer program product for training the project implementation model based on an archived requirement feature and an archived responsive resource allocation unit.

In some embodiments, the computer program code, in execution with at least one processor, configures the computer program product for generating a project implementation electronic record interface component. In some embodiments, the project implementation electronic record interface component comprises a project implementation electronic record representation. In some embodiments, the computer program code, in execution with at least one processor, configures the computer program product for causing rendering of the project implementation electronic record interface component to a project implementation electronic record interface.

In some embodiments, the computer program code, in execution with at least one processor, configures the computer program product for executing one or more project implementation computing scripts.

In some embodiments, the computer program code, in execution with at least one processor, configures the computer program product for identifying a project implementation impact event associated with the project implementation electronic record. In some embodiments, the computer program code, in execution with at least one processor, configures the computer program product for generating a reconfigured project implementation electronic record based on the project implementation impact event. In some embodiments, the computer program code, in execution with at least one processor, configures the computer program product for performing one or more reconfigured project implementation actions based on the reconfigured project implementation electronic record.

In some embodiments, identifying the project implementation impact event comprises receiving the project implementation impact event from an external project application device or a project foundation device.

In some embodiments, at least one of the one or more project implementation actions is performed prior to identifying the project implementation impact event.

In some embodiments, the computer program code, in execution with at least one processor, configures the computer program product for generating a reconfigured project implementation electronic record interface component. In some embodiments, the reconfigured project implementation electronic record interface component comprises a reconfigured project implementation electronic record representation. In some embodiments, the computer program code, in execution with at least one processor, configures the computer program product for causing rendering of the reconfigured project implementation electronic record interface component to a project implementation electronic record interface.

In some embodiments, the computer program code, in execution with at least one processor, configures the computer program product for executing one or more project implementation computing scripts.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of the environment in which embodiments of the present disclosure may operate;

FIG. 3 illustrates an example block diagram of an example apparatus that may be specially configured in accordance with an example embodiment of the present disclosure;

FIG. 4 illustrates an example interface component in accordance with an example embodiment of the present disclosure;

FIG. 5 illustrates another example interface component in accordance with an example embodiment of the present disclosure;

FIG. 6 illustrates a flowchart of an example method in accordance with one or more embodiments of the present disclosure;

FIG. 7 illustrates a flowchart of an example method in accordance with one or more embodiments of the present disclosure;

FIG. 8 illustrates a flowchart of an example method in accordance with one or more embodiments of the present disclosure;

FIG. 9 illustrates a flowchart of an example method in accordance with one or more embodiments of the present disclosure; and

FIG. 10 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### OVERVIEW

Example embodiments disclosed herein address technical problems associated with systems, apparatuses, methods, and computer program products for real-time project services operations. As would be understood by one skilled in the field to which this disclosure pertains, there are numerous example scenarios in which systems, apparatuses, methods, and computer program products for real-time project services operations are needed. For example, it may be desirable to use systems, apparatuses, methods, and computer program products for real-time project services operations to generate a project implementation electronic record for a project related to generating a temperature control system for a building.

Example solutions for real-time project services operations include using computing devices to implement real-time project services operations. However, such example solutions are simplistic, inefficient, and reactive. For example, such example solutions are simplistic because such example solutions do not implement a plurality of predictive computing entities to execute discrete tasks using generative artificial intelligence to implement real-time project services operations. As another example, such example solutions are inefficient because such example solutions do not leverage a project implementation model for generating responsive resource allocation units and project implementation electronic records for real-time project services operations. As another example, such example solutions are reactive because such example solutions do not automatically implement project implementation actions based on project implementation electronic records. Accordingly, there is a need for systems, apparatuses, methods, and computer program products that perform real-time project services operations in a sophisticated, efficient, and proactive manner.

Thus, to address these and/or other issues related to such example solutions, example systems, apparatuses, methods, and computer program products for real-time project services operations are disclosed herein. For example, an embodiment in this disclosure, described in greater detail below, includes a method that includes accessing, at a project orchestration predictive computing entity, a requirement electronic record, wherein the requirement electronic record comprises a requirement feature. In some embodiments, the method comprises generating, using a project operations predictive computing entity, a responsive resource allocation unit by applying the requirement feature to a project implementation model. In some embodiments, the method comprises extracting, using the project operations predictive computing entity, a set of free resource unit objects from a plurality of free resource unit objects based on the responsive resource allocation unit. In some embodiments, the method comprises generating, using the project operations predictive computing entity, a project implementation electronic record by applying the set of free resource unit objects to the project implementation model. In some embodiments, the method comprises performing, using the project orchestration predictive computing entity, one or more project implementation actions based on the project implementation electronic record.

Further embodiments and advantages of the example systems, apparatuses, methods, and computer program products disclosed herein are described in the following co-pending U.S. patent applications: U.S. Application No. 63/790,880, titled “SYSTEMS, APPARATUSES, METHODS, AND COMPUTER PROGRAM PRODUCTS FOR AUTOMATED PROJECT OPERATIONS ARCHITECTURE”; U.S. Application No. 63/790,876, titled “SYSTEMS, APPARATUSES, METHODS, AND COMPUTER PROGRAM PRODUCTS FOR AN INTERACTIVE PROJECT REQUIREMENTS ANALYSIS ENGINE”; U.S. Application No. 63/790,873, titled “SYSTEMS, APPARATUSES, METHODS, AND COMPUTER PROGRAM PRODUCTS FOR A PROJECT OUTCOME PREDICTIVE ENGINE”; U.S. Application No. 63/790,878, titled “SYSTEMS, APPARATUSES, METHODS, AND COMPUTER PROGRAM PRODUCTS FOR NEW PROJECT GENERATION”; U.S. Application No. 63/790,875, titled “SYSTEMS, APPARATUSES, METHODS, AND COMPUTER PROGRAM PRODUCTS FOR GENERATING A NEW PHYSICAL COMPONENT”; U.S. Application No. 63/790,882, titled “SYSTEMS, APPARATUSES, METHODS, AND COMPUTER PROGRAM PRODUCTS FOR REAL-TIME PROJECT INVENTORY OPTIMIZATION”; U.S. Application No. 63/790,889, titled “SYSTEMS, APPARATUSES, METHODS, AND COMPUTER PROGRAM PRODUCTS FOR PROJECT PROGRAM GENERATION”; U.S. Application No. 63/790,892, titled “SYSTEMS, APPARATUSES, METHODS, AND COMPUTER PROGRAM PRODUCTS FOR AUTOMATED PROJECT QUALITY CONTROL”; U.S. Application No. 63/790,879, titled “SYSTEMS, APPARATUSES, METHODS, AND COMPUTER PROGRAM PRODUCTS FOR AI DRIVEN PROJECT COMPLIANCE FORECASTING”, each of which is filed concurrently with the present application. The contents of each of the foregoing applications are hereby incorporated by reference in their entirety.

### Example Systems and Apparatuses

Embodiments of the present disclosure herein include systems, apparatuses, methods, and computer program products configured for real-time project services operations. It should be readily appreciated that the embodiments of the apparatus, systems, methods, and computer program product described herein may be configured in various additional and alternative manners in addition to those expressly described herein.

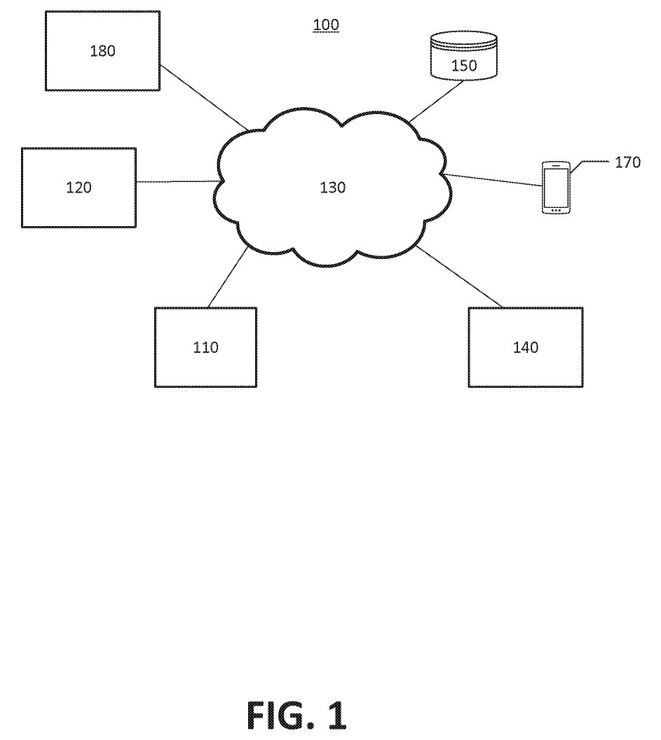

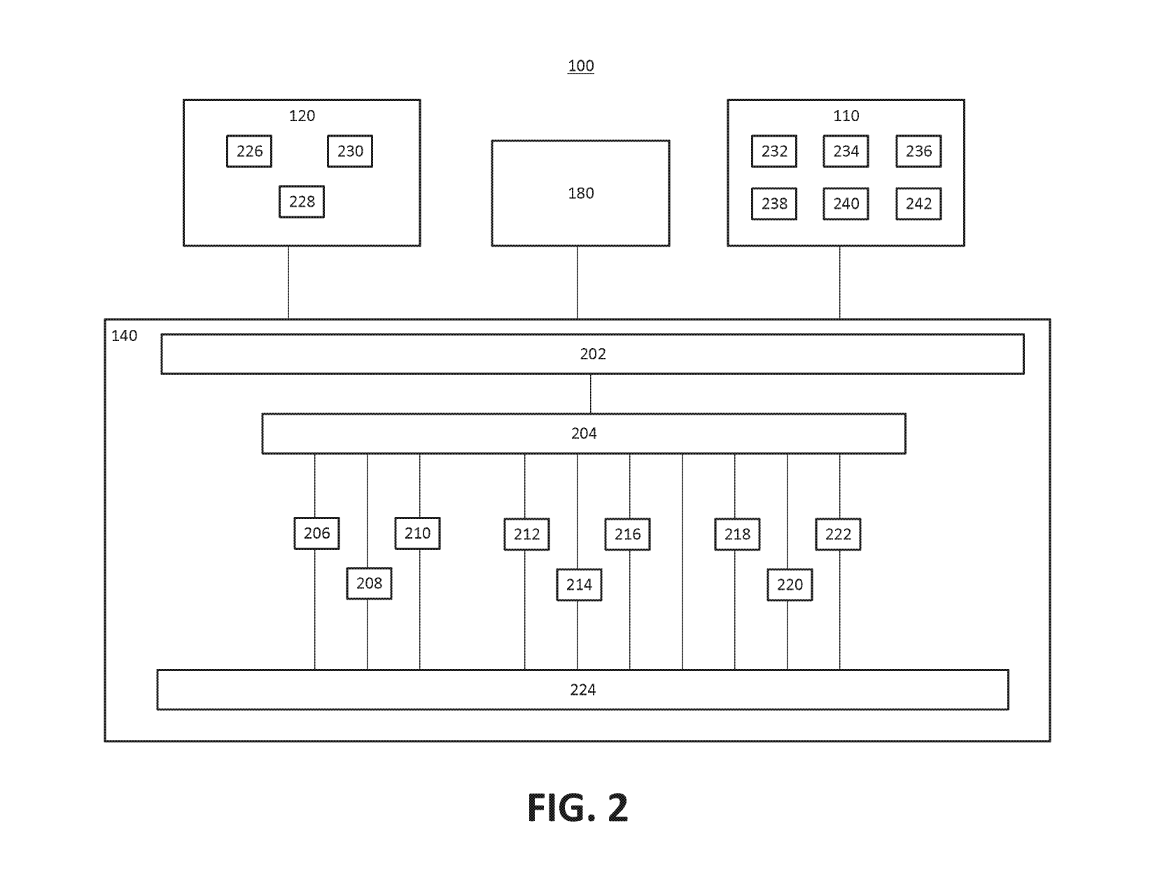

FIGS. 1 and 2 illustrate exemplary block diagrams of an environment 100 in which embodiments of the present disclosure may operate. In some embodiments, the environment 100 comprises a cloud-based project operations device 140. In some embodiments, the cloud-based project operations device 140 is electronically and/or communicatively coupled to a project foundation device 180, an external project implementation device 120, an external project application device 110, one or more databases 150, and/or the user device 170. The cloud-based project operations device 140 may be located remotely from the project foundation device 180, the external project implementation device 120, the external project application device 110, the one or more databases 150, and/or the user device 170. In this regard, for example, the cloud-based project operations device 140 may be located in a remote cloud server and electronically and/or communicatively coupled to the project foundation device 180, the external project implementation device 120, the external project application device 110, the one or more databases 150, and/or the user device 170 via at least the network 130. In some embodiments, the cloud-based project operations device 140 is configured via hardware, software, firmware, and/or a combination thereof, to perform data intake of one or more types of data.

Additionally, or alternatively, in some embodiments, the cloud-based project operations device 140 is configured via hardware, software, firmware, and/or a combination thereof, to generate and/or transmit command(s) that control, adjust, or otherwise impact operations of one or more of the project foundation device 180, the external project implementation device 120, the external project application device 110, the one or more databases 150, and/or the user device 170. Additionally, or alternatively, in some embodiments, the cloud-based project operations device 140 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the external project application device 110, the one or more databases 150, and/or the user device 170. For example, in various embodiments, the cloud-based project operations device 140 may be configured to execute and/or perform one or more operations and/or functions described herein.

In some embodiments, the cloud-based project operations device 140 comprises a project operations security layer 202 configured to execute and/or perform one or more operations and/or functions described herein. For example, the project operations security layer 202 may be configured to control access permissions for the cloud-based project operations device 140. In some embodiments, the cloud-based project operations device 140 comprises a project orchestration predictive computing entity 204 configured to execute and/or perform one or more operations and/or functions described herein. In some embodiments, the cloud-based project operations device 140 comprises one or more internal predictive computing entities configured to execute and/or perform one or more operations and/or functions described herein. For example, the cloud-based project operations device 140 may comprise an inventory predictive computing entity 206, a program predictive computing entity 208, a project condition predictive computing entity 210, a project record predictive computing entity 212, a project component engineering predictive computing entity 214, a project command predictive computing entity 216, a project prompt predictive computing entity 218, a project operations predictive computing entity 220, a project services predictive computing entity 222, and/or the like. In some embodiments, the cloud-based project operations device 140 comprises an internal database 224 configured to execute and/or perform one or more operations and/or functions described herein. For example, the internal database 224 may be a vectorized database.

In some embodiments, the environment 100 comprises the external project implementation device 120. In some embodiments, the external project implementation device 120 is electronically and/or communicatively coupled to the project foundation device 180, the external project application device 110, the cloud-based project operations device 140, the one or more databases 150, and/or the user device 170. The external project implementation device 120 may be located remotely from the project foundation device 180, the external project application device 110, the cloud-based project operations device 140, the one or more databases 150, and/or the user device 170. In this regard, for example, the external project implementation device 120 may be located in a remote cloud server and electronically and/or communicatively coupled to the project foundation device 180, the external project application device 110, the cloud-based project operations device 140, the one or more databases 150, and/or the user device 170 via at least the network 130. In some embodiments, the external project implementation device 120 is configured via hardware, software, firmware, and/or a combination thereof, to perform data intake of one or more types of data.

Additionally, or alternatively, in some embodiments, the external project implementation device 120 is configured via hardware, software, firmware, and/or a combination thereof, to generate and/or transmit command(s) that control, adjust, or otherwise impact operations of one or more of the project foundation device 180, the external project application device 110, the cloud-based project operations device 140, the one or more databases 150, and/or the user device 170. Additionally, or alternatively, in some embodiments, the external project implementation device 120 is configured via hardware, software, firmware, and/or a combination thereof, to perform data reporting, provide data, and/or other data output process(es) associated with monitoring or otherwise analyzing operations of one or more of the project foundation device 180, the external project application device 110, the cloud-based project operations device 140, the one or more databases 150, and/or the user device 170. For example, in various embodiments, the external project implementation device 120 may be configured to execute and/or perform one or more operations and/or functions described herein.

In some embodiments, the external project implementation device 120 comprises one or more external predictive computing entities configured to execute and/or perform one or more operations and/or functions described herein. For example, the external project implementation device 120 may comprise a project extraction predictive computing entity 226, a project code predictive computing entity 228, a project bot predictive computing entity 230, and/or the like.

In some embodiments, the environment 100 comprises an external project application device 110. In some embodiments, the external project application device 110 is electronically and/or communicatively coupled to the project foundation device 180, the external project implementation device 120, the cloud-based project operations device 140, the one or more databases 150, and/or the user device 170. The external project application device 110 may be located remotely from the project foundation device 180, the external project implementation device 120, the cloud-based project operations device 140, the one or more databases 150, and/or the user device 170. In this regard, for example, the external project application device 110 may be located in a remote cloud server and electronically and/or communicatively coupled to the project foundation device 180, the external project implementation device 120, the cloud-based project operations device 140, the one or more databases 150, and/or the user device 170 via at least the network 130. In some embodiments, the external project application device 110 is configured via hardware, software, firmware, and/or a combination thereof, to perform data intake of one or more types of data.

Additionally, or alternatively, in some embodiments, the external project application device 110 is configured via hardware, software, firmware, and/or a combination thereof, to generate and/or transmit command(s) that control, adjust, or otherwise impact operations of one or more of the project foundation device 180, the external project implementation device 120, the cloud-based project operations device 140, the one or more databases 150, and/or the user device 170. Additionally, or alternatively, in some embodiments, the external project application device 110 is configured via hardware, software, firmware, and/or a combination thereof, to perform data reporting, provide data, and/or other data output process(es) associated with monitoring or otherwise analyzing operations of one or more of the project foundation device 180, the external project implementation device 120, the cloud-based project operations device 140, the one or more databases 150, and/or the user device 170. For example, in various embodiments, the external project application device 110 may be configured to execute and/or perform one or more operations and/or functions described herein.

In some embodiments, the external project application device 110 comprises one or more external computing applications configured to execute and/or perform one or more operations and/or functions described herein. For example, THE external project application device 110 may comprise a project operations computing application 232, a project impact value computing application 234, a project documentation computing application 236, a project component computing application 238, a project generation computing application 240, a project automation computing application 242, and/or the like.

In some embodiments, the environment 100 comprises the project foundation device 180. In some embodiments, the project foundation device 180 is electronically and/or communicatively coupled to the external project implementation device 120, the external project application device 110, the cloud-based project operations device 140, the one or more databases 150, and/or the user device 170. The project foundation device 180 may be located remotely from the external project implementation device 120, the external project application device 110, the cloud-based project operations device 140, the one or more databases 150, and/or the user device 170. In this regard, for example, the project foundation device 180 may be located in a remote cloud server and electronically and/or communicatively coupled to the external project implementation device 120, the external project application device 110, the cloud-based project operations device 140, the one or more databases 150, and/or the user device 170 via at least the network 130. In some embodiments, the project foundation device 180 is configured via hardware, software, firmware, and/or a combination thereof, to perform data intake of one or more types of data.

Additionally, or alternatively, in some embodiments, the project foundation device 180 is configured via hardware, software, firmware, and/or a combination thereof, to generate and/or transmit command(s) that control, adjust, or otherwise impact operations of one or more of the external project implementation device 120, the external project application device 110, the cloud-based project operations device 140, the one or more databases 150, and/or the user device 170. Additionally, or alternatively, in some embodiments, the project foundation device 180 is configured via hardware, software, firmware, and/or a combination thereof, to perform data reporting, provide data, and/or other data output process(es) associated with monitoring or otherwise analyzing operations of one or more of the external project implementation device 120, the external project application device 110, the cloud-based project operations device 140, the one or more databases 150, and/or the user device 170. For example, in various embodiments, the project foundation device 180 may be configured to execute and/or perform one or more operations and/or functions described herein.

The one or more databases 150 may be configured to receive, store, and/or transmit data. In some embodiments, the one or more databases 150 may be associated with data associated with the project foundation device 180, the external project implementation device 120, the external project application device 110, the cloud-based project operations device 140, and/or the user device 170. In some embodiments, the data may be received from the project foundation device 180, the external project implementation device 120, the external project application device 110, the cloud-based project operations device 140, and/or the user device 170. In some embodiments, the one or more databases 150 may be associated with data received from the project foundation device 180, the external project implementation device 120, the external project application device 110, the cloud-based project operations device 140, and/or the user device 170 in real-time. Additionally, or alternatively, the one or more databases 150 may be associated with data received from the project foundation device 180, the external project implementation device 120, the external project application device 110, the cloud-based project operations device 140, and/or the user device 170 on a periodic basis (e.g., the data may be received from the project foundation device 180, the external project implementation device 120, the external project application device 110, the cloud-based project operations device 140, the one or more databases 150, and/or the user device 170 once per day). Additionally, or alternatively, the one or more databases 150 may be associated with data received from the project foundation device 180, the external project implementation device 120, the external project application device 110, the cloud-based project operations device 140, and/or the user device 170 in response to a request for the data. Additionally, or alternatively, the one or more databases 150 may be associated with data inputted (e.g., by a user) into the project foundation device 180, the external project implementation device 120, the external project application device 110, the cloud-based project operations device 140, and/or the user device 170.

The user device 170 may be associated with users of the project foundation device 180, the external project implementation device 120, the external project application device 110, the cloud-based project operations device 140, and/or the one or more databases 150. In various embodiments, the project foundation device 180, the external project implementation device 120, the external project application device 110, the cloud-based project operations device 140, and/or the one or more databases 150 may generate and/or transmit a message, alert, or indication to a user via a user device 170. Additionally, or alternatively, a user device 170 may be utilized by a user to remotely access the project foundation device 180, the external project implementation device 120, the external project application device 110, the cloud-based project operations device 140, and/or the one or more databases 150. This may be by, for example, an application operating on the user device 170. A user may access the project foundation device 180, the external project implementation device 120, the external project application device 110, the cloud-based project operations device 140, and/or the one or more databases 150, remotely, including one or more visualizations, reports, and/or real-time displays.

In some embodiments, the project foundation device 180, the external project implementation device 120, the external project application device 110, the cloud-based project operations device 140, the one or more databases 150, and/or the user device 170 is associated with a determinable location. In some embodiments, the determinable location of the project foundation device 180, the external project implementation device 120, the external project application device 110, the cloud-based project operations device 140, the one or more databases 150, and/or the user device 170 represents an absolute position (e.g., GPS coordinates, latitude, and longitude locations, and/or the like) and/or a relative position (e.g., a point representation of the location of the project foundation device 180, the external project implementation device 120, the external project application device 110, the cloud-based project operations device 140, the one or more databases 150, and/or the user device 170 from a local origin point). In some embodiments, the project foundation device 180, the external project implementation device 120, the external project application device 110, the cloud-based project operations device 140, the one or more databases 150, and/or the user device 170 includes or otherwise is associated with a location sensor and/or software-driven location services that provide the location data representing the location corresponding to that the project foundation device 180, the external project implementation device 120, the external project application device 110, the cloud-based project operations device 140, the one or more databases 150, and/or the user device 170. In other embodiments the location of the project foundation device 180, the external project implementation device 120, the external project application device 110, the cloud-based project operations device 140, the one or more databases 150, and/or the user device 170 is stored and/or otherwise predetermined within a software environment, provided by a user and/or otherwise determinable to one or more systems.

Additionally, while FIGS. 1 and 2 illustrate certain components as separate, standalone entities communicating over the network 130, various embodiments are not limited to this configuration. In other embodiments, one or more components may be directly connected and/or share hardware or the like.

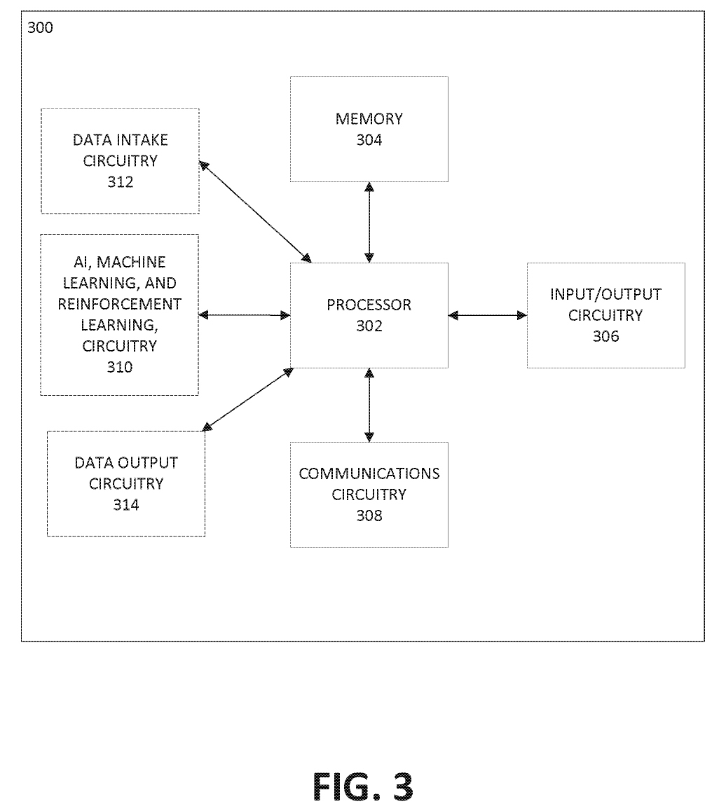

FIG. 3 illustrates an exemplary block diagram of an example apparatus that may be specially configured in accordance with an example embodiment of the present disclosure. Specifically, FIG. 3 depicts an example computing apparatus 300 (“apparatus 300”) specially configured in accordance with at least some example embodiments of the present disclosure. For example, the computing apparatus 300 may be embodied as one or more of a specifically configured personal computing apparatus, a specifically configured cloud-based computing apparatus, a specifically configured embedded computing device (e.g., configured for edge computing, and/or the like). Examples of an apparatus 300 may include, but is not limited to, the project foundation device 180, the external project implementation device 120, the external project application device 110, the cloud-based project operations device 140, the one or more databases 150, and/or the user device 170. The apparatus 300 includes processor 302, memory 304, input/output circuitry 306, communications circuitry 308, and/or optional artificial intelligence (“AI”) and machine learning circuitry 310. In some embodiments, the apparatus 300 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 300 of the project foundation device 180, the external project implementation device 120, the external project application device 110, the cloud-based project operations device 140, the one or more databases 150, and/or the user device 170 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 300 embodies a particular, specially configured computing entity transformed to enable the specific operations described herein and provide the specific advantages associated therewith, as described herein.

Processor 302 or processor circuity 302 may be embodied in a number of different ways. In various embodiments, the use of the terms “processor” should be understood to include a single core processor, a multi-core processor, multiple processors internal to the apparatus 300, and/or one or more remote or “cloud” processor(s) external to the apparatus 300. In some example embodiments, processor 302 may include one or more processing devices configured to perform independently. Alternatively, or additionally, processor 302 may include one or more processor(s) configured in tandem via a bus to enable independent execution of operations, instructions, pipelining, and/or multithreading.

In an example embodiment, the processor 302 may be configured to execute instructions stored in the memory 304 or otherwise accessible to the processor. Alternatively, or additionally, the processor 302 may be configured to execute hard-coded functionality. As such, whether configured by hardware or software methods, or by a combination thereof, processor 302 may represent an entity (e.g., physically embodied in circuitry) capable of performing operations according to embodiments of the present disclosure while configured accordingly. Alternatively, or additionally, processor 302 may be embodied as an executor of software instructions, and the instructions may specifically configure the processor 302 to perform the various algorithms embodied in one or more operations described herein when such instructions are executed. In some embodiments, the processor 302 includes hardware, software, firmware, and/or a combination thereof that performs one or more operations described herein.

In some embodiments, the processor 302 (and/or co-processor or any other processing circuitry assisting or otherwise associated with the processor) is/are in communication with the memory 304 via a bus for passing information among components of the apparatus 300.

Memory 304 or memory circuitry 304 may be non-transitory and may include, for example, one or more volatile and/or non-volatile memories. In some embodiments, the memory 304 includes or embodies an electronic storage device (e.g., a computer readable storage medium). In some embodiments, the memory 304 is configured to store information, data, content, applications, instructions, or the like, for enabling an apparatus 300 to carry out various operations and/or functions in accordance with example embodiments of the present disclosure.

Input/output circuitry 306 may be included in the apparatus 300. In some embodiments, input/output circuitry 306 may provide output to the user and/or receive input from a user. The input/output circuitry 306 may be in communication with the processor 302 to provide such functionality. The input/output circuitry 306 may comprise one or more user interface(s). In some embodiments, a user interface may include a display that comprises the interface(s) rendered as a web user interface, an application user interface, a user device, a backend system, or the like. In some embodiments, the input/output circuitry 306 also includes a keyboard, a mouse, a joystick, a touch screen, touch areas, soft keys a microphone, a speaker, or other input/output mechanisms. The processor 302 and/or input/output circuitry 306 comprising the processor may be configured to control one or more operations and/or functions of one or more user interface elements through computer program instructions (e.g., software and/or firmware) stored on a memory accessible to the processor (e.g., memory 304, and/or the like). In some embodiments, the input/output circuitry 306 includes or utilizes a user-facing application to provide input/output functionality to a computing device and/or other display associated with a user.

Communications circuitry 308 may be included in the apparatus 300. The communications circuitry 308 may include any means such as a device or circuitry embodied in either hardware or a combination of hardware and software that is configured to receive and/or transmit data from/to a network and/or any other device, circuitry, or module in communication with the apparatus 300. In some embodiments the communications circuitry 308 includes, for example, a network interface for enabling communications with a wired or wireless communications network. Additionally, or alternatively, the communications circuitry 308 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 308 may include circuitry for interacting with an antenna(s) and/or other hardware or software to cause transmission of signals via the antenna(s) and/or to handle receipt of signals received via the antenna(s). In some embodiments, the communications circuitry 308 enables transmission to and/or receipt of data from a user device, one or more sensors, and/or other external computing device(s) in communication with the apparatus 300.

Data intake circuitry 312 may be included in the apparatus 300. The data intake circuitry 312 may include hardware, software, firmware, and/or a combination thereof, designed and/or configured to capture, receive, request, and/or otherwise gather data associated with operations of the project foundation device 180, the external project implementation device 120, the external project application device 110, the cloud-based project operations device 140, the one or more databases 150, and/or the user device 170. In some embodiments, the data intake circuitry 312 includes hardware, software, firmware, and/or a combination thereof, that communicates with one or more sensor(s) unit(s), and/or the like within the project foundation device 180, the external project implementation device 120, the external project application device 110, the cloud-based project operations device 140, the one or more databases 150, and/or the user device 170 to receive particular data. Additionally, or alternatively, in some embodiments, the data intake circuitry 312 includes hardware, software, firmware, and/or a combination thereof, that retrieves particular data associated with the project foundation device 180, the external project implementation device 120, the external project application device 110, the cloud-based project operations device 140, the one or more databases 150, and/or the user device 170 from one or more data repository/repositories accessible to the apparatus 300.

AI and machine learning circuitry 310 may be included in the apparatus 300. The AI and machine learning circuitry 310 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 310 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 310 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 310 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 314 may be included in the apparatus 300. The data output circuitry 314 may include hardware, software, firmware, and/or a combination thereof, that configures and/or generates an output based at least in part on data processed by the apparatus 300. In some embodiments, the data output circuitry 314 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 314 includes hardware, software, firmware, and/or a combination thereof, that configures a particular output data object, output data file, and/or user interface for storing, transmitting, and/or displaying. For example, in some embodiments, the data output circuitry 314 generates and/or specially configures a particular data output for transmission to another system sub-system for further processing. Additionally, or alternatively, in some embodiments, the data output circuitry 314 includes hardware, software, firmware, and/or a combination thereof, that causes rendering of a specially configured user interface based at least in part on data received by and/or processing by the apparatus 300.

In some embodiments, two or more of the sets of circuitries 302-314 are combinable. Alternatively, or additionally, one or more of the sets of circuitry 302-314 perform some or all of the operations and/or functionality described herein as being associated with another circuitry. In some embodiments, two or more of the sets of circuitry 302-314 are combined into a single module embodied in hardware, software, firmware, and/or a combination thereof. For example, in some embodiments, one or more of the sets of circuitry, for example the AI and machine learning circuitry 310, may be combined with the processor 302, such that the processor 302 performs one or more of the operations described herein with respect to the AI and machine learning circuitry 310.

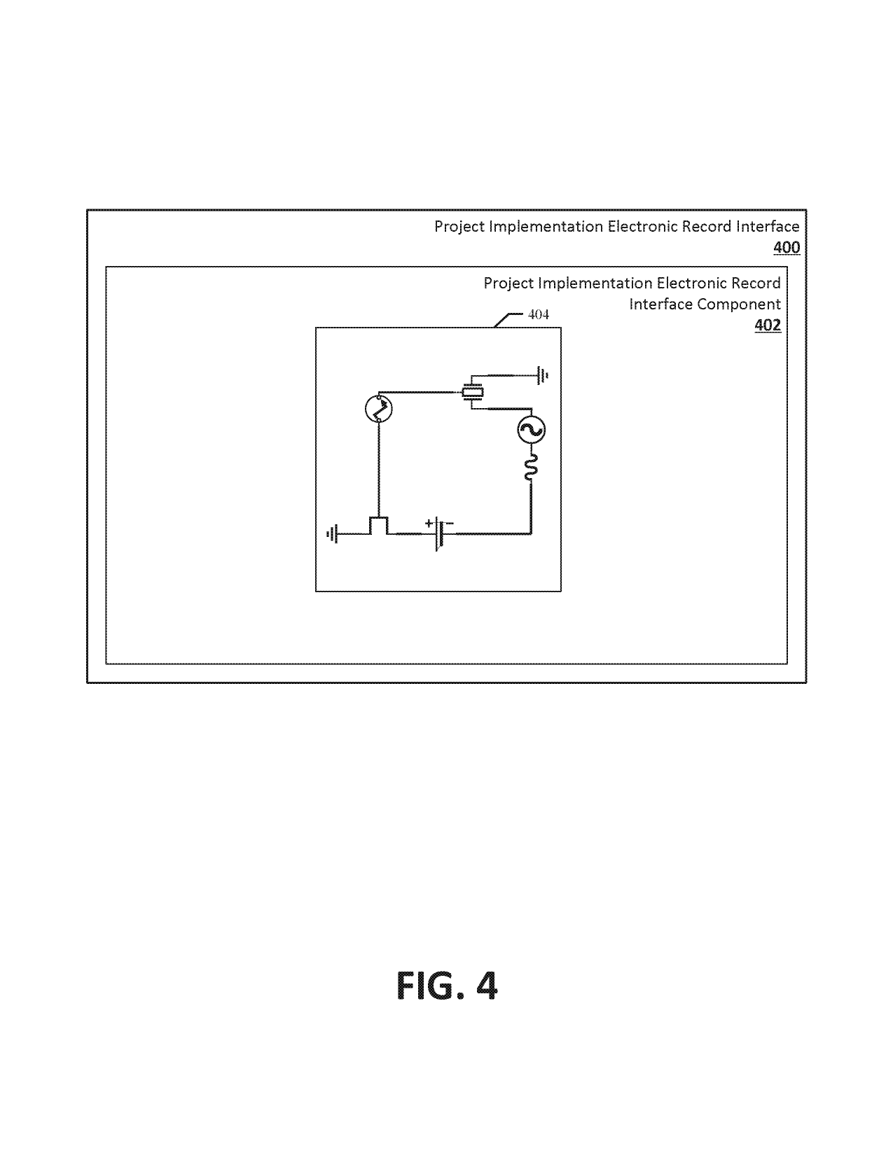

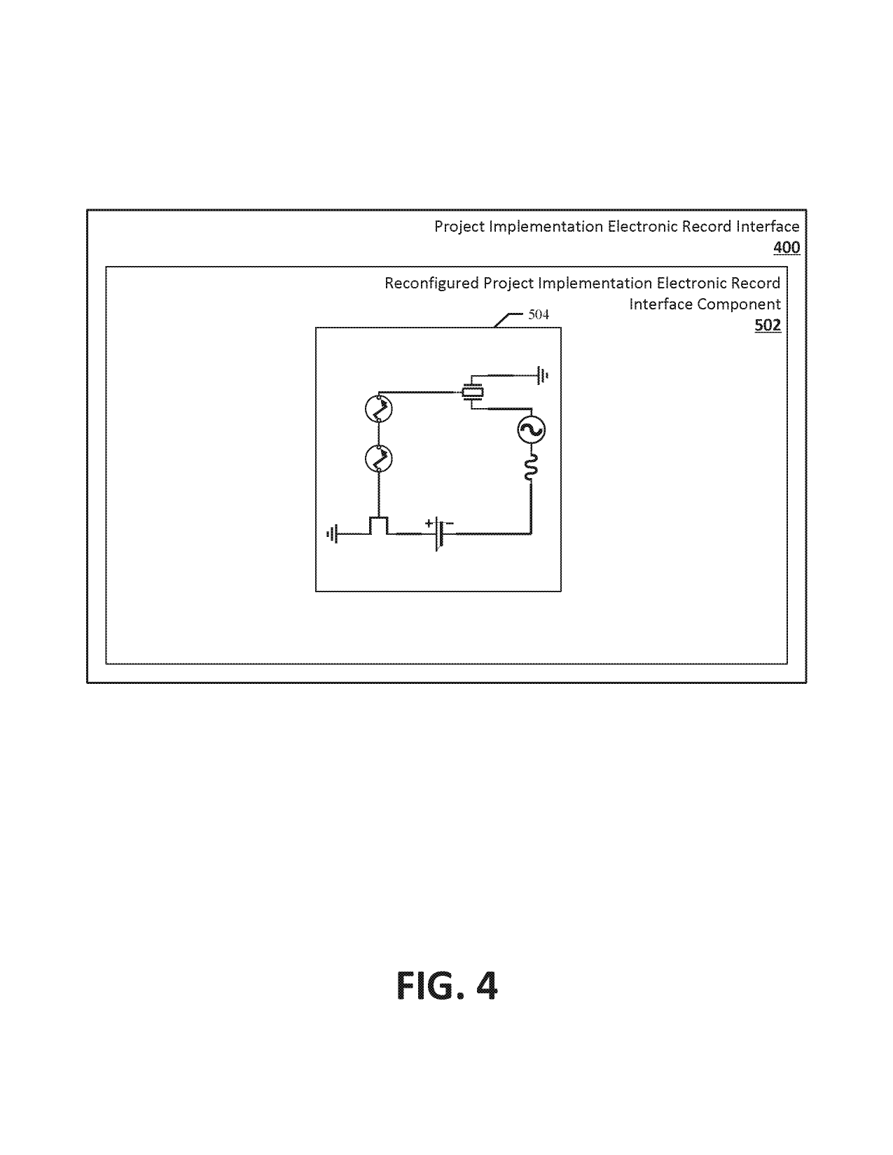

With reference to FIGS. 1-5, in some embodiments, a project may be a collection of components that may be implemented in a configured manner to accomplish one or more tasks. In this regard, for example, a project may be a collection of components that may be implemented in a configured manner in order to control the temperature of a building. For example, a project may be a collection of physical components that include temperature sensors, temperature control systems, circuits, and/or heating, ventilation, and air conditioning (HVAC) units that may be implemented in order to control the temperature of a building. In this regard, in some embodiments, a physical component may be any component configured to, in combination with other components, construct a configured component such as a temperature sensor, circuit, or HVAC unit.

In some embodiments, a physical component object comprises one or more items of data representative of a physical component that may be implemented in a project. For example, a physical component object may be representative of a temperature sensor, a circuit, an HVAC unit or any discrete, individual component used to construct a temperature sensor, a circuit, or an HVAC unit. Said differently, for example, a physical component object may be representative of a physical component that may form a portion of a project.

In some embodiments, a project and/or a physical component object is associated with a physical component implementation unit. In some embodiments, a physical component implementation unit comprises one or more items of data representative of resources needed to design, engineer, test, implement, configure, and/or acquire one or more physical components associated with a project. In this regard, in some embodiments, a physical component implementation unit may comprise one or more items of data representative of one or more temporal resources, logistical resources, geographic resources, and/or implementation resources. In some embodiments, a temporal resource comprises an amount of time required to design, engineer, test, implement, configure, and/or acquire one or more physical components associated with a project. In some embodiments, a logistical resource comprises one or more external implementers (e.g., external software applications, external inventory providers, etc.) required to design, engineer, test, implement, configure, and/or acquire one or more physical components associated with a project. In some embodiments, a geographic resource comprises one or more locations (e.g., machines, factories, project sites, etc.) required to design, engineer, test, implement, configure, and/or acquire one or more physical components associated with a project. In some embodiments, an implementation resource comprises one or more engineers, designers, manufacturers, and/or the like required to design, engineer, test, implement, configure, and/or acquire one or more physical components associated with a project. In some embodiments, the cloud-based project operations device 140 is configured to access a requirement electronic record. For example, the cloud-based project operations device 140 may be configured to access a requirement electronic record at the project orchestration predictive computing entity 204 (e.g., the cloud-based project operations device 140 is configured to access a requirement electronic record using the project orchestration predictive computing entity 204).

In some embodiments, a requirement electronic record comprises an electronic record that is representative of one or more requirement features (e.g., a requirement electronic record comprises one or more electronic records). In this regard, in some embodiments, a requirement electronic record may be one or more of a text document, a schematic drawing, a 3D model, a computer-aided design (CAD) file, an image, a video, and/or the like. For example, a requirement electronic record may be a schematic drawing that depicts one or more requirement features. As another example, a requirement electronic record may be a video that depicts one or more requirement features. As another example, a requirement electronic recordmay be a text document that describes one or more requirement features. As another example, a requirement electronic recordmay be a 3D model that depicts one or more requirement features. As another example, requirement electronic record may be a computer-aided design (CAD) file that describes and/or depicts one or more requirement features. As another example, requirement electronic record may be an image that depicts one or more requirement features.

In some embodiments, a requirement feature comprises one or more items of data representative of a requirement, a criteria, and/or a constraint that must be satisfied in order to implement a proposed project (e.g., a project that has not yet been implemented). For example, a requirement feature may be one or more items of data that are representative of a requirement, a criteria, and/or a constraint that must be satisfied in order to implement a proposed project that includes controlling the temperature of a building. In this regard, for example, a requirement feature may be representative of a particular range in which the temperature of a building must be controlled to stay within (e.g., a requirement). As another example, a requirement feature may be representative of a physical layout of a building in which the temperature is to be controlled (e.g., a constraint). As another example, a requirement feature may be representative of an implementation time for a proposed project (e.g., how long it may take to implement a proposed project, when a proposed project must be implemented, etc.). As another example, a requirement feature may be representative of a geographic location associated with a proposed project (e.g., where a project should be implemented, a restriction on where resources for proposed project should be obtained from, etc.).

In some embodiments, accessing a requirement electronic record comprises the cloud-based project operations device 140 being configured to retrieve a requirement electronic record. For example, the cloud-based project operations device 140 may be configured to retrieve a requirement electronic record from the one or more databases 150 using the project orchestration predictive computing entity 204. As another example, cloud-based project operations device 140 may be configured to retrieve a requirement electronic record from the internal databases 224 using the project orchestration predictive computing entity 204. In some embodiments, accessing a requirement electronic record comprises the cloud-based project operations device 140 being configured to receive a requirement electronic record. For example, the cloud-based project operations device 140 may be configured to receive a requirement electronic record from the project foundation device 180. As another example, the cloud-based project operations device 140 may be configured to receive a requirement electronic record from the external project application device 110. In some embodiments, prior to the cloud-based project operations device 140 accessing a requirement electronic record at the project orchestration predictive computing entity 204, a requirement electronic record may be processed by the project operations security layer 202 using one or more cybersecurity operations. In some embodiments, accessing a requirement electronic record comprises the cloud-based project operations device 140 providing access to a requirement electronic record to project operations predictive computing entity 220 via project orchestration predictive computing entity 204.

In some embodiments, the cloud-based project operations device 140 is configured to generate a responsive resource allocation unit. For example, the cloud-based project operations device 140 may be configured to generate a responsive resource allocation unit using the project operations predictive computing entity 220. In some embodiments, a responsive resource allocation unit comprises one or more items of data representative of a physical component object representative of a physical component that satisfies a requirement feature associated with a requirement electronic record accessed by the cloud-based project operations device 140. Said differently, for example, a responsive resource allocation unit may comprise one or more items of data representative of a physical component object representative of a physical component that may satisfy a requirement, a criteria, and/or a constraint of a requirement associated with a requirement electronic record accessed by the cloud-based project operations device 140. Additionally, or alternatively, a responsive resource allocation unit comprises one or more items of data representative of a physical component implementation unit associated with a physical component that satisfies a requirement feature associated with a requirement electronic record accessed by the cloud-based project operations device 140 (e.g., associated with a physical component object represented by a responsive resource allocation unit).

In some embodiments, the cloud-based project operations device 140 is configured to generate a responsive resource allocation unit by applying a requirement feature to a project implementation model. In this regard, in some embodiments, generating a responsive resource allocation unit comprises the cloud-based project operations device 140 being configured to, using the project implementation model, determine a physical component object representative of a physical component that satisfies a requirement feature associated with a requirement electronic record accessed by the cloud-based project operations device 140. In some embodiments, the project implementation model is configured to determine a physical component object representative of a physical component that satisfies a requirement feature associated with a requirement electronic record accessed by the cloud-based project operations device 140 by performing at least one electronic filtering operations of a set of electronic filtering operations. In this regard, in some embodiments, the cloud-based project operations device 140 is configured to perform at least one electronic filtering operation to identify a physical component object representative of a physical component that satisfies a requirement feature associated with a requirement electronic record accessed by the cloud-based project operations device 140 from a set of physical component objects.

In some embodiments, the set of electronic filtering operations comprises a text-based filtering operation. In some embodiments, a text-based filtering operation comprises identifying a first sequence of characters from a requirement electronic record using an optical character recognition (OCR) technique. In some embodiments, a text-based filtering operation comprises identifying one or more other sequences of characters from a set of physical component objects using an optical character recognition (OCR) technique. In some embodiments, a text-based filtering operation comprises comparing the first sequence of characters with one or more of the one or more other sequences of characters. In this regard, for example, the cloud-based project operations device 140 may identify a physical component object representative of a physical component that satisfies a requirement feature associated with a requirement electronic record by finding a match between the first sequence of characters and the one or more of the one or more other sequences of characters.

In some embodiments, the cloud-based project operations device 140 may leverage the project extraction predictive computing entity 226 to execute an optical character recognition (OCR) technique (e.g., the project extraction predictive computing entity 226 may be configured to perform an optical character recognition (OCR) technique). In some embodiments, the set of electronic filtering operations comprises a geometry-based filtering operation. In some embodiments, a geometry-based filtering operation comprises identifying a geometric element from a requirement electronic record. In some embodiments, a geometry-based filtering operation comprises identifying one or more other geometric elements from a set of physical component objects. In some embodiments, a geometry-based filtering operation comprises comparing the geometric element with one or more of the one or more other geometric elements. In this regard, for example, the cloud-based project operations device 140 may identify a physical component object representative of a physical component that satisfies a requirement feature associated with a requirement electronic record by finding a match between the geometric element and the one or more of the one or more other geometric elements.

In some embodiments, the set of electronic filtering operations comprises a design-based filtering operation. In some embodiments, a design-based filtering operation comprises identifying a data encoding from a requirement electronic record. For example, a data encoding may comprises one or more of an svg, .dwg, .tiff, .png, .obj, .amf, .stl, and/or .glb data encoding. In some embodiments, a design-based filtering operation comprises identifying one or more other data encodings from a set of physical component objects. In some embodiments, a design-based filtering operation comprises comparing the data encoding with one or more of the one or more other data encodings. In this regard, for example, the cloud-based project operations device 140 may identify a physical component object representative of a physical component that satisfies a requirement feature associated with a requirement electronic record by finding a match between the data encoding and the one or more of the one or more other data encodings.

In some embodiments, the set of electronic filtering operations comprises a sketch-based filtering operation. In some embodiments, a sketch-based filtering operation comprises identifying a sketch feature from a requirement electronic record. For example, a sketch feature may be representative of a feature of a sketch or 3D model. In some embodiments, a sketch-based filtering operation comprises identifying one or more other sketch features from a set of physical component objects. In some embodiments, a sketch-based filtering operation comprises comparing the sketch feature with one or more of the one or more other sketch features. In this regard, for example, the cloud-based project operations device 140 may identify a physical component object representative of a physical component that satisfies a requirement feature associated with a requirement electronic record by finding a match between the sketch feature and the one or more of the one or more other sketch features.

In some embodiments, the set of electronic filtering operations comprises a topology-based filtering operation. In some embodiments, a topology-based filtering operation comprises identifying a topology feature from a requirement electronic record. For example, topology feature may be data representative of a component configuration, architecture indicating connections between several components, and/or an organization of information in an electronic record. In some embodiments, a topology-based filtering operation comprises identifying one or more other topology features from a set of physical component objects. In some embodiments, a topology-based filtering operation comprises comparing the topology feature with one or more of the one or more other topology features. In this regard, for example, the cloud-based project operations device 140 may identify a physical component object representative of a physical component that satisfies a requirement feature associated with a requirement electronic record by finding a match between the topology feature and the one or more of the one or more other topology features.

In some embodiments, the set of electronic filtering operations comprises a color-based filtering operation. In some embodiments, a color-based filtering operation comprises identifying first pixel data from a requirement electronic record. In some embodiments, a color-based filtering operation comprises identifying other pixel data from a set of physical component objects. For example, first pixel data and/or other pixel data may be representative of colors, color usage patterns, and/or color coordinates in an electronic record. In some embodiments, a color-based filtering operation comprises comparing the first pixel data with the other pixel data. In this regard, for example, the cloud-based project operations device 140 may identify a physical component object representative of a physical component that satisfies a requirement feature associated with a requirement electronic record by finding a match between the first pixel data and the other pixel data.

In some embodiments, generating a responsive allocation unit comprises the cloud-based project operations device 140 being configured to, using the project implementation model, determine a physical component implementation unit corresponding to a physical component object that satisfies a requirement feature associated with a requirement electronic record accessed by the cloud-based project operations device 140. In this regard, in some embodiments, the project implementation model may be configured to determine the resources needed to design, engineer, test, implement, configure, and/or acquire one or more physical components that have been identified by the project implementation model by performing at least one electronic filtering operations of a set of electronic filtering operations.

In some embodiments, the cloud-based project operations device 140 is configured to store a responsive resource allocation unit and/or a requirement feature in the one or more databases 150 and/or internal database 224. For example, the cloud-based project operations device 140 is configured to store a responsive resource allocation unit and/or the requirement feature in the one or more databases 150 and/or internal database 224 after the cloud-based project operations device 140 has generated a responsive resource allocation unit by applying a corresponding requirement feature to the project implementation model. In some embodiments, by storing a responsive resource allocation unit in the one or more databases 150 and/or internal database 224, the cloud-based project operations device 140 is configured to generate an archived responsive resource allocation unit (e.g., once stored in the one or more databases 150 and/or internal database 224, a responsive resource allocation unit becomes an archived responsive resource allocation unit). Additionally, or alternatively, by storing a requirement feature in the one or more databases 150 and/or internal database 224, the cloud-based project operations device 140 is configured to generate an archived requirement feature (e.g., once stored in the one or more databases 150 and/or internal database 224, a requirement feature becomes an archived requirement feature).

In some embodiments, the cloud-based project operations device 140 is configured to extract a set of free resource unit objects from a plurality of resource unit objects. In some embodiments, the cloud-based project operations device 140 may be configured to extract a set of free resource unit objects from a plurality of resource unit objects using the project operations predictive computing entity 220. In some embodiments, a resource unit object (e.g., of a plurality of resource unit objects) comprises one or more items of data representative of one or more physical components that are associated with the cloud-based project operations device 140. For example, a resource unit object may comprise one or more items of data representative of one or more temperature sensors, circuits, HVAC units or any discrete, individual component used to construct a temperature sensor, a circuit, or an HVAC unit that are associated with the cloud-based project operations device 140. Said differently, for example, a resource unit object may comprise one or more items of data representative of one or more physical components associated with cloud-based project operations device 140 that could potentially be used by the cloud-based project operations device 140 to implement a project.

Additionally, or alternatively, a resource unit object (e.g., of a plurality of resource unit objects) comprises one or more items of data representative of one or more physical component implementation units that are associated with the cloud-based project operations device 140. For example, a resource unit object may comprise one or more items of data representative of one or more resources (e.g., temporal resources, logistical resources, geographic resources, and/or implementation resources) needed to design, engineer, test, implement, configure, and/or acquire one or more physical components associated with the cloud-based operations device 140. Said differently, for example, a resource unit object may comprise one or more items of data representative of one or more resources associated with cloud-based project operations device 140 that could potentially be used by the cloud-based project operations device 140 to implement a physical component associated with the cloud-based project operations device 140.

In some embodiments, a free resource unit object (e.g., of a set of free resource unit objects) comprises one or more items of data representative of one or more resource unit objects that correspond to a responsive resource allocation unit generated by the cloud-based project operations device 140. For example, a free resource unit object may comprise one or more items of data representative of one or more physical component objects that correspond to a responsive resource allocation unit generated by the cloud-based project operations device 140. As another example, a free resource unit object may comprise one or more items of data representative of one or more resources (e.g., temporal resources, logistical resources, geographic resources, and/or implementation resources) needed to design, engineer, test, implement, configure, and/or acquire one or more physical components that correspond to a responsive resource allocation unit generated by the cloud-based project operations device 140. Said differently, a set of free resource unit objects may comprise one or more resource unit objects from a plurality of resource unit objects associated with the cloud-based project operations device that may be used to implement a particular project associated with a particular requirement electronic record accessed by the cloud-based project operations device 140.

In some embodiments, the cloud-based project operations device 140 is configured to extract a set of free resource unit objects from a plurality of resource unit objects based on a responsive resource allocation unit. In this regard, in some embodiments, the cloud-based project operations device 140 is configured to extract a set of free resource unit objects from a plurality of resource unit objects by matching resource unit objects of a plurality of resource unit objects associated with the cloud-based project operations device 140 with a responsive resource allocation unit. For example, the cloud-based project operations device 140 may be configured to extract a free resource unit object representative of a physical component object from a plurality of resource unit objects by matching the free resource unit object with a physical component object represented by a responsive resource allocation unit. As another example, the cloud-based project operations device 140 may configured to extract a free resource unit object representative of a resource from a plurality of resource unit objects by matching the free resource unit object with a resource represented by a responsive resource allocation unit.

In some embodiments, the cloud-based project operations device 140 is configured to generate a project implementation electronic record (e.g., using the project operations predictive computing entity 220). For example, the cloud-based project operations device 140 is configured to generate a project implementation electronic record by applying a set of free resource unit objects to the project implementation model. In this regard, in some embodiments, a project implementation electronic record comprises an electronic record that describes a plan, design, and/or process for implementing a project using a set of free resource unit objects. For example, a project implementation electronic record may comprise an electronic record that describes a plan, design, and/or process for implementing a project using one or more physical components associated with a set of free resource unit objects. As another example, a project implementation electronic record may comprise an electronic record that describes a plan, design, and/or process for implementing a project using one or more resources associated with a set of free resource unit objects.

In some embodiments, the cloud-based project operations device 140 is configured to perform one or more project implementation actions. For example, the cloud-based project operations device 140 is configured to perform one or more project implementation actions using the project orchestration predictive computing entity 204. In some embodiments, the cloud-based project operations device 140 is configured to perform one or more project implementation actions based on the project implementation electronic record. In this regard, for example, the cloud-based project operations device 140 may be configured to perform one or more project implementation actions in order to execute, implement, and/or the like a plan, design, and/or process for implementing a project using a set of free resource unit objects.

In some embodiments, performing one or more project implementation actions comprises the cloud-based project operations device 140 being configured to generate a project implementation electronic record interface component 402. In some embodiments, the project implementation electronic record interface component 402 is configured to display a project implementation electronic record representation 404 that is representative of one or more project implementation electronic records. For example, the project implementation electronic record representation 404 may be a representation of a project implementation electronic record that comprises a plan for implementing the proposed project corresponding to a requirement electronic record based on a set of free resource unit objects.

In some embodiments, performing one or more project implementation actions comprises the cloud-based project operations device 140 being configured to cause a project implementation electronic record interface component 402 to be rendered to project implementation electronic record interface 400. In some embodiments, the project implementation electronic record interface 400 may be provided on a display associated with the cloud-based project operations device 140 and/or a display associated with the project foundation device 180.

In some embodiments, performing one or more project implementation actions comprises the cloud-based project operations device 140 being configured to execute one or more project implementation computing scripts. In this regard, in some embodiments, the one or more project implementation computing scripts comprise executable code configured to cause execution of at least a portion of a plan, design, and/or process for implementing a project. In some embodiments, execution of one or more project implementation computing scripts comprises executing code that causes procurement of physical components and/or resources associated with a project implementation electronic record. In some embodiments, execution of one or more project implementation computing scripts comprises executing code that causes allocation of physical components and/or resources associated with a project implementation electronic record associated with a project implementation electronic record to a project. In some embodiments, execution of one or more project implementation computing scripts comprises executing code that causes actuation of a device that manufactures a physical component associated with a project implementation electronic record (e.g., to turn on, create the physical component, and/or to shut down). In some embodiments, execution of one or more project implementation computing scripts comprises executing code that causes generation of a physical component associated with a project implementation electronic record delegation of project tasks to one or more third party manufacturers. In some embodiments, execution of one or more project implementation computing scripts comprises executing code that causes initiation of a relocation of physical components and/or resources associated with a project implementation electronic record to a new geographic location. In some embodiments, causes removal from a project of physical components and/or resources associated with a project implementation electronic record. In some embodiments, execution of one or more project implementation computing scripts comprises executing code that causes reassignment of physical components and/or resources associated with a different project to a project associated with a project implementation electronic record. In some embodiments, execution of one or more project implementation computing scripts comprises executing code that generates a proposed project quote. In some embodiments, execution of one or more project implementation computing scripts comprises executing code that causes generation of a proposed project timeline.

In some embodiments, the cloud-based project operations device 140 is configured to identify a project implementation impact event associated with a project implementation electronic record. In some embodiments, the one or more project implementation actions may be performed prior to identifying the project implementation impact event. In some embodiments, a project implementation impact event is any occurrence that causes a change to the responsive resource allocation unit associated with a project implementation electronic record. In this regard, in some embodiments, a project implementation impact event may comprise a change to the requirement electronic record, a change to one or more requirement features, and/or the like. In some embodiments, a project implementation impact event is any occurrence that causes a change to a free resource unit object associated with a project implementation electronic record. In some embodiments, identifying a project implementation impact event comprises the cloud-based project operations device 140 being configured to receive the project implementation impact event from external project application device 110. In some embodiments, identifying a project implementation impact event comprises the cloud-based project operations device 140 being configured to receive the project implementation impact event from project foundation device 180.

In some embodiments, the cloud-based project operations device 140 is configured to generate a reconfigured project implementation electronic record (e.g., using the project operations predictive computing entity 220). In some embodiments, the cloud-based project operations device 140 to generate a reconfigured project implementation electronic record based on a project implementation impact event. For example, the cloud-based project operations device 140 may be configured to generate a reconfigured project implementation electronic record based on a project implementation impact event that includes a change to a requirement electronic record, a change to one or more requirement features, and/or the like. As another example, the cloud-based project operations device 140 may be configured to generate a reconfigured project implementation electronic record based on a project implementation impact event that includes a change to a free resource unit object associated with a project implementation electronic record. Said differently, for example, the cloud-based project operations device 140 is configured to generate a reconfigured project implementation electronic record that factors in the reconfigured project implementation electronic record by using a similar process as described above with respect to generating a project implementation electronic record.

In some embodiments, the cloud-based project operations device 140 is configured to perform one or more reconfigured project implementation actions. For example, the cloud-based project operations device 140 is configured to perform one or more reconfigured project implementation actions using the project orchestration predictive computing entity 204. In some embodiments, the cloud-based project operations device 140 is configured to perform one or more reconfigured project implementation actions based on the reconfigured project implementation electronic record. In this regard, for example, the cloud-based project operations device 140 may be configured to perform one or more reconfigured project implementation actions in order to execute, implement, and/or the like a plan, design, and/or process for implementing a project using a set of free resource unit objects.

In some embodiments, performing one or more reconfigured project implementation actions comprises the cloud-based project operations device 140 being configured to generate a reconfigured project implementation electronic record interface component 502. In some embodiments, the reconfigured project implementation electronic record interface component 502 is configured to display a reconfigured project implementation electronic record representation 504 that is representative of one or more reconfigured project implementation electronic records. For example, the reconfigured project implementation electronic record representation 504 may be a representation of a reconfigured project implementation electronic record that comprises a reconfigured plan for implementing the proposed project corresponding to a requirement electronic record based on a set of free resource unit objects and the project implementation impact event.

In some embodiments, performing one or more reconfigured project implementation actions comprises the cloud-based project operations device 140 being configured to cause a reconfigured project implementation electronic record interface component 502 to be rendered to project implementation electronic record interface 400. In some embodiments, the project implementation electronic record interface 400 may be provided on a display associated with the cloud-based project operations device 140 and/or a display associated with the project foundation device 180.

In some embodiments, performing one or more reconfigured project implementation actions comprises the cloud-based project operations device 140 being configured to execute one or more reconfigured project implementation computing scripts. In this regard, in some embodiments, the one or more reconfigured project implementation computing scripts comprise executable code configured to cause execution of at least a portion of a plan, design, and/or process for implementing a project. In some embodiments, execution of one or more reconfigured project implementation computing scripts comprises executing code that causes procurement of physical components and/or resources associated with a reconfigured project implementation electronic record. In some embodiments, execution of one or more reconfigured project implementation computing scripts comprises executing code that causes generation of a project delay prediction. In some embodiments, execution of one or more reconfigured project implementation computing scripts comprises executing code that causes generation of a supply chain delay prediction. In some embodiments, execution of one or more reconfigured project implementation computing scripts comprises executing code that causes generation of an alternative physical component supplier recommendation. In some embodiments, execution of one or more reconfigured project implementation computing scripts comprises executing code that causes generation of a project proposal success rate estimation. In some embodiments, execution of one or more reconfigured project implementation computing scripts comprises executing code that causes generation of a reconfigured impact value estimation. In some embodiments, execution of one or more reconfigured project implementation computing scripts comprises executing code that causes generation of a reconfigured impact result estimation. In some embodiments, execution of one or more reconfigured project implementation computing scripts comprises executing code that causes procurement of one or more physical components.

In some embodiments, execution of one or more reconfigured project implementation computing scripts comprises executing code that causes allocation of one or more resources to a project or proposed project. In some embodiments, execution of one or more reconfigured project implementation computing scripts comprises executing code that causes actuation of a device to manufacture a physical component. In some embodiments, execution of one or more reconfigured project implementation computing scripts comprises executing code that causes delegation of project tasks to members of a workforce. In some embodiments, execution of one or more reconfigured project implementation computing scripts comprises executing code that causes delegation of project tasks to one or more third party contractors. In some embodiments, execution of one or more reconfigured project implementation computing scripts comprises executing code that causes initiation of a relocation of physical components and/or resources associated with a project implementation electronic record to a new geographic location. In some embodiments, causes removal from a project of physical components and/or resources associated with a project implementation electronic record. In some embodiments, execution of one or more reconfigured project implementation computing scripts comprises executing code that causes reassignment of physical components and/or resources associated with a different project to a project associated with a project implementation electronic record. In some embodiments, execution of one or more reconfigured project implementation computing scripts comprises executing code that generates a proposed project quote. In some embodiments, execution of one or more reconfigured project implementation computing scripts comprises executing code that causes generation of a proposed project timeline.

In some embodiments, the project implementation model comprises hardware and/or software that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate a responsive resource allocation unit, generate a project implementation electronic record, determine a physical component object corresponding to a requirement feature, determine a physical component implementation unit based on a physical component object, generate a reconfigured responsive resource allocation unit, and/or generate a reconfigured project implementation electronic record. In this regard, in some embodiments, the project implementation model may be configured to utilize one or more of any type of machine learning, rules-based, and/or artificial intelligence techniques including one or more of clustering techniques (e.g., k-means techniques, expectation maximization techniques, centroid neural network techniques), computer vision techniques, supervised learning (e.g., using user feedback), unsupervised learning, semi-supervised learning, reinforcement learning, sequence modeling techniques, language processing techniques, neural network techniques, and/or generative artificial intelligence techniques. In some embodiments, the project implementation model comprises one or more layers. For example, the project implementation model may comprise a first layer configured to generate a responsive resource allocation unit. As another example, the project implementation model may comprise a second layer configured to generate a project implementation electronic record.

In some embodiments, the cloud-based project operations device 140 is configured to train the project implementation model. In some embodiments, the cloud-based project operations device 140 is configured to train the project implementation model based on an archived requirement feature. Additionally, or alternatively, the cloud-based project operations device 140 is configured to train the project implementation model based on an archived responsive resource allocation unit. Additionally, or alternatively, the cloud-based project operations device 140 is configured to train the project implementation model based on an archived project implementation electronic record. In this regard, in some embodiments, requirement features, responsive resource allocation units, and/or project implementation electronic records previously accessed and/or generated by the cloud-based project operations device 140 may be able to be used by the cloud-based project operations device 140 to continually improve the project implementation model.

### Example Methods

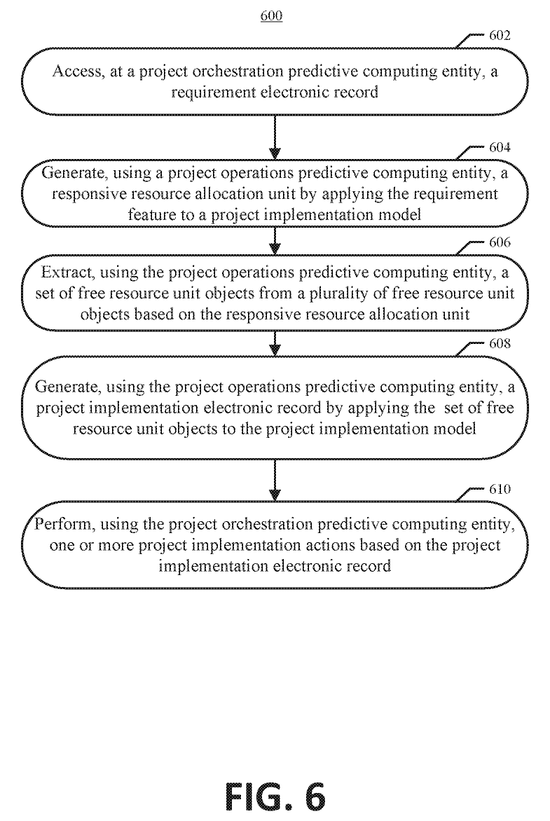

Referring now to FIG. 6, a flowchart providing an example method 600 is illustrated. In this regard, FIG. 6 illustrates operations that may be performed by the project foundation device 180, the external project implementation device 120, the external project application device 110, the cloud-based project operations device 140, the one or more databases 150, and/or the user device 170. In some embodiments, the method 600 comprises operations for generating a project implementation record by applying a responsive resource allocation unit and a set of free resource unit objects to a project implementation model. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600.

As shown in block 602, the method 600 may comprise accessing, at a project orchestration predictive computing entity, a requirement electronic record. In some embodiments, the requirement electronic record comprises a requirement feature.

As described above, in some embodiments, a requirement electronic record comprises an electronic record that is representative of one or more requirement features (e.g., a requirement electronic record comprises one or more electronic records). In this regard, in some embodiments, a requirement electronic record may be one or more of a text document, a schematic drawing, a 3D model, a computer-aided design (CAD) file, an image, a video, and/or the like. For example, a requirement electronic record may be a schematic drawing that depicts one or more requirement features. As another example, a requirement electronic record may be a video that depicts one or more requirement features. As another example, a requirement electronic recordmay be a text document that describes one or more requirement features. As another example, a requirement electronic recordmay be a 3D model that depicts one or more requirement features. As another example, requirement electronic record may be a computer-aided design (CAD) file that describes and/or depicts one or more requirement features. As another example, requirement electronic record may be an image that depicts one or more requirement features.

In some embodiments, a requirement feature comprises one or more items of data representative of a requirement, a criteria, and/or a constraint that must be satisfied in order to implement a proposed project (e.g., a project that has not yet been implemented). For example, a requirement feature may be one or more items of data that are representative of a requirement, a criteria, and/or a constraint that must be satisfied in order to implement a proposed project that includes controlling the temperature of a building. In this regard, for example, a requirement feature may be representative of a particular range in which the temperature of a building must be controlled to stay within (e.g., a requirement). As another example, a requirement feature may be representative of a physical layout of a building in which the temperature is to be controlled (e.g., a constraint). As another example, a requirement feature may be representative of an implementation time for a proposed project (e.g., how long it may take to implement a proposed project, when a proposed project must be implemented, etc.). As another example, a requirement feature may be representative of a geographic location associated with a proposed project (e.g., where a project should be implemented, a restriction on where resources for proposed project should be obtained from, etc.).

In some embodiments, accessing a requirement electronic record comprises the cloud-based project operations device 140 being configured to retrieve a requirement electronic record. For example, the cloud-based project operations device 140 may be configured to retrieve a requirement electronic record from the one or more databases 150 using the project orchestration predictive computing entity 204. As another example, cloud-based project operations device 140 may be configured to retrieve a requirement electronic record from the internal databases 224 using the project orchestration predictive computing entity 204. In some embodiments, accessing a requirement electronic record comprises the cloud-based project operations device 140 being configured to receive a requirement electronic record. For example, the cloud-based project operations device 140 may be configured to receive a requirement electronic record from the project foundation device 180. As another example, the cloud-based project operations device 140 may be configured to receive a requirement electronic record from the external project application device 110. In some embodiments, prior to the cloud-based project operations device 140 accessing a requirement electronic record at the project orchestration predictive computing entity 204, a requirement electronic record may be processed by the project operations security layer 202 using one or more cybersecurity operations. In some embodiments, accessing a requirement electronic record comprises the cloud-based project operations device 140 providing access to a requirement electronic record to project operations predictive computing entity 220 via project orchestration predictive computing entity 204.

As shown in block 604, the method 600 may comprise generating, using a project operations predictive computing entity, a responsive resource allocation unit by applying the requirement feature to a project implementation model.

As described above, in some embodiments, the cloud-based project operations device 140 is configured to generate a responsive resource allocation unit. For example, the cloud-based project operations device 140 may be configured to generate a responsive resource allocation unit using the project operations predictive computing entity 220. In some embodiments, a responsive resource allocation unit comprises one or more items of data representative of a physical component object representative of a physical component that satisfies a requirement feature associated with a requirement electronic record accessed by the cloud-based project operations device 140. Said differently, for example, a responsive resource allocation unit may comprise one or more items of data representative of a physical component object representative of a physical component that may satisfy a requirement, a criteria, and/or a constraint of a requirement associated with a requirement electronic record accessed by the cloud-based project operations device 140. Additionally, or alternatively, a responsive resource allocation unit comprises one or more items of data representative of a physical component implementation unit associated with a physical component that satisfies a requirement feature associated with a requirement electronic record accessed by the cloud-based project operations device 140 (e.g., associated with a physical component object represented by a responsive resource allocation unit).

In some embodiments, the cloud-based project operations device 140 is configured to generate a responsive resource allocation unit by applying a requirement feature to a project implementation model. In this regard, in some embodiments, generating a responsive resource allocation unit comprises the cloud-based project operations device 140 being configured to, using the project implementation model, determine a physical component object representative of a physical component that satisfies a requirement feature associated with a requirement electronic record accessed by the cloud-based project operations device 140. In some embodiments, the project implementation model is configured to determine a physical component object representative of a physical component that satisfies a requirement feature associated with a requirement electronic record accessed by the cloud-based project operations device 140 by performing at least one electronic filtering operations of a set of electronic filtering operations. In this regard, in some embodiments, the cloud-based project operations device 140 is configured to perform at least one electronic filtering operation to identify a physical component object representative of a physical component that satisfies a requirement feature associated with a requirement electronic record accessed by the cloud-based project operations device 140 from a set of physical component objects.

As shown in block 606, the method 600 may comprise extracting, using the project operations predictive computing entity, a set of free resource unit objects from a plurality of free resource unit objects.

As described above, in some embodiments, the cloud-based project operations device 140 is configured to extract a set of free resource unit objects from a plurality of resource unit objects. In some embodiments, the cloud-based project operations device 140 may be configured to extract a set of free resource unit objects from a plurality of resource unit objects using the project operations predictive computing entity 220. In some embodiments, a resource unit object (e.g., of a plurality of resource unit objects) comprises one or more items of data representative of one or more physical components that are associated with the cloud-based project operations device 140. For example, a resource unit object may comprise one or more items of data representative of one or more temperature sensors, circuits, HVAC units or any discrete, individual component used to construct a temperature sensor, a circuit, or an HVAC unit that are associated with the cloud-based project operations device 140. Said differently, for example, a resource unit object may comprise one or more items of data representative of one or more physical components associated with cloud-based project operations device 140 that could potentially be used by the cloud-based project operations device 140 to implement a project.

Additionally, or alternatively, a resource unit object (e.g., of a plurality of resource unit objects) comprises one or more items of data representative of one or more physical component implementation units that are associated with the cloud-based project operations device 140. For example, a resource unit object may comprise one or more items of data representative of one or more resources (e.g., temporal resources, logistical resources, geographic resources, and/or implementation resources) needed to design, engineer, test, implement, configure, and/or acquire one or more physical components associated with the cloud-based operations device 140. Said differently, for example, a resource unit object may comprise one or more items of data representative of one or more resources associated with cloud-based project operations device 140 that could potentially be used by the cloud-based project operations device 140 to implement a physical component associated with the cloud-based project operations device 140.

In some embodiments, a free resource unit object (e.g., of a set of free resource unit objects) comprises one or more items of data representative of one or more resource unit objects that correspond to a responsive resource allocation unit generated by the cloud-based project operations device 140. For example, a free resource unit object may comprise one or more items of data representative of one or more physical component objects that correspond to a responsive resource allocation unit generated by the cloud-based project operations device 140. As another example, a free resource unit object may comprise one or more items of data representative of one or more resources (e.g., temporal resources, logistical resources, geographic resources, and/or implementation resources) needed to design, engineer, test, implement, configure, and/or acquire one or more physical components that correspond to a responsive resource allocation unit generated by the cloud-based project operations device 140. Said differently, a set of free resource unit objects may comprise one or more resource unit objects from a plurality of resource unit objects associated with the cloud-based project operations device that may be used to implement a particular project associated with a particular requirement electronic record accessed by the cloud-based project operations device 140.

In some embodiments, the cloud-based project operations device 140 is configured to extract a set of free resource unit objects from a plurality of resource unit objects based on a responsive resource allocation unit. In this regard, in some embodiments, the cloud-based project operations device 140 is configured to extract a set of free resource unit objects from a plurality of resource unit objects by matching resource unit objects of a plurality of resource unit objects associated with the cloud-based project operations device 140 with a responsive resource allocation unit. For example, the cloud-based project operations device 140 may be configured to extract a free resource unit object representative of a physical component object from a plurality of resource unit objects by matching the free resource unit object with a physical component object represented by a responsive resource allocation unit. As another example, the cloud-based project operations device 140 may configured to extract a free resource unit object representative of a resource from a plurality of resource unit objects by matching the free resource unit object with a resource represented by a responsive resource allocation unit.

As shown in block 608, the method 600 may comprise generating, using the project operations predictive computing entity, a project implementation electronic record by applying the responsive resource allocation unit and the set of free resource unit objects to the project implementation model.

As described above, in some embodiments, the cloud-based project operations device 140 is configured to generate a project implementation electronic record (e.g., using the project operations predictive computing entity 220). For example, the cloud-based project operations device 140 is configured to generate a project implementation electronic record by applying a set of free resource unit objects to the project implementation model. In this regard, in some embodiments, a project implementation electronic record comprises an electronic record that describes a plan, design, and/or process for implementing a project using a set of free resource unit objects. For example, a project implementation electronic record may comprise an electronic record that describes a plan, design, and/or process for implementing a project using one or more physical components associated with a set of free resource unit objects. As another example, a project implementation electronic record may comprise an electronic record that describes a plan, design, and/or process for implementing a project using one or more resources associated with a set of free resource unit objects.

As shown in block 610, the method 600 may comprise performing, using the project orchestration predictive computing entity, one or more project implementation actions based on the project implementation electronic record.

As described above, in some embodiments, the cloud-based project operations device 140 is configured to perform one or more project implementation actions. For example, the cloud-based project operations device 140 is configured to perform one or more project implementation actions using the project orchestration predictive computing entity 204. In some embodiments, the cloud-based project operations device 140 is configured to perform one or more project implementation actions based on the project implementation electronic record. In this regard, for example, the cloud-based project operations device 140 may be configured to perform one or more project implementation actions in order to execute, implement, and/or the like a plan, design, and/or process for implementing a project using a set of free resource unit objects.

In some embodiments, performing one or more project implementation actions comprises the cloud-based project operations device 140 being configured to generate a project implementation electronic record interface component 402. In some embodiments, the project implementation electronic record interface component 402 is configured to display a project implementation electronic record representation 404 that is representative of one or more project implementation electronic records. For example, the project implementation electronic record representation 404 may be a representation of a project implementation electronic record that comprises a plan for implementing the proposed project corresponding to a requirement electronic record based on a set of free resource unit objects.

In some embodiments, performing one or more project implementation actions comprises the cloud-based project operations device 140 being configured to cause a project implementation electronic record interface component 402 to be rendered to project implementation electronic record interface 400. In some embodiments, the project implementation electronic record interface 400 may be provided on a display associated with the cloud-based project operations device 140 and/or a display associated with the project foundation device 180.

In some embodiments, performing one or more project implementation actions comprises the cloud-based project operations device 140 being configured to execute one or more project implementation computing scripts. In this regard, in some embodiments, the one or more project implementation computing scripts comprise executable code configured to cause execution of at least a portion of a plan, design, and/or process for implementing a project. In some embodiments, execution of one or more project implementation computing scripts comprises executing code that causes procurement of physical components and/or resources associated with a project implementation electronic record. In some embodiments, execution of one or more project implementation computing scripts comprises executing code that causes allocation of physical components and/or resources associated with a project implementation electronic record associated with a project implementation electronic record to a project.

In some embodiments, execution of one or more project implementation computing scripts comprises executing code that causes actuation of a device that manufactures a physical component associated with a project implementation electronic record (e.g., to turn on, create the physical component, and/or to shut down). In some embodiments, execution of one or more project implementation computing scripts comprises executing code that causes generation of a physical component associated with a project implementation electronic record delegation of project tasks to one or more third party manufacturers. In some embodiments, execution of one or more project implementation computing scripts comprises executing code that causes initiation of a relocation of physical components and/or resources associated with a project implementation electronic record to a new geographic location. In some embodiments, causes removal from a project of physical components and/or resources associated with a project implementation electronic record. In some embodiments, execution of one or more project implementation computing scripts comprises executing code that causes reassignment of physical components and/or resources associated with a different project to a project associated with a project implementation electronic record. In some embodiments, execution of one or more project implementation computing scripts comprises executing code that generates a proposed project quote. In some embodiments, execution of one or more project implementation computing scripts comprises executing code that causes generation of a proposed project timeline.

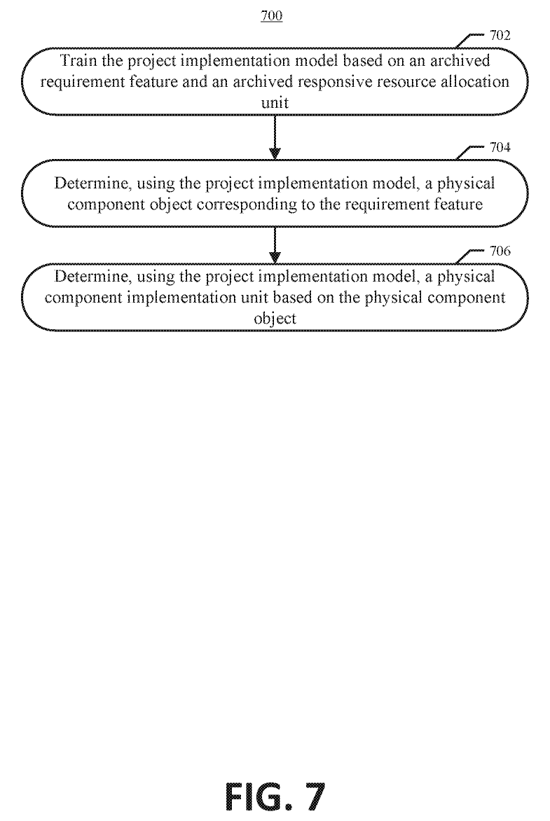

Referring now to FIG. 7, a flowchart providing an example method 700 is illustrated. In this regard, FIG. 7 illustrates operations that may be performed by the project foundation device 180, the external project implementation device 120, the external project application device 110, the cloud-based project operations device 140, the one or more databases 150, and/or the user device 170. In some embodiments, the method 700 comprises operations for generating a responsive resource allocation unit by applying the requirement feature to a project implementation model. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700.

As shown in block 702, the method 700 may comprise training the project implementation model based on an archived requirement feature and an archived responsive resource allocation unit.

As described above, in some embodiments, the cloud-based project operations device 140 is configured to store a responsive resource allocation unit and/or a requirement feature in the one or more databases 150 and/or internal database 224. For example, the cloud-based project operations device 140 is configured to store a responsive resource allocation unit and/or the requirement feature in the one or more databases 150 and/or internal database 224 after the cloud-based project operations device 140 has generated a responsive resource allocation unit by applying a corresponding requirement feature to the project implementation model. In some embodiments, by storing a responsive resource allocation unit in the one or more databases 150 and/or internal database 224, the cloud-based project operations device 140 is configured to generate an archived responsive resource allocation unit (e.g., once stored in the one or more databases 150 and/or internal database 224, a responsive resource allocation unit becomes an archived responsive resource allocation unit). Additionally, or alternatively, by storing a requirement feature in the one or more databases 150 and/or internal database 224, the cloud-based project operations device 140 is configured to generate an archived requirement feature (e.g., once stored in the one or more databases 150 and/or internal database 224, a requirement feature becomes an archived requirement feature).

In some embodiments, the project implementation model comprises hardware and/or software that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate a responsive resource allocation unit, generate a project implementation electronic record, determine a physical component object corresponding to a requirement feature, determine a physical component implementation unit based on a physical component object, generate a reconfigured responsive resource allocation unit, and/or generate a reconfigured project implementation electronic record. In this regard, in some embodiments, the project implementation model may be configured to utilize one or more of any type of machine learning, rules-based, and/or artificial intelligence techniques including one or more of clustering techniques (e.g., k-means techniques, expectation maximization techniques, centroid neural network techniques), computer vision techniques, supervised learning (e.g., using user feedback), unsupervised learning, semi-supervised learning, reinforcement learning, sequence modeling techniques, language processing techniques, neural network techniques, and/or generative artificial intelligence techniques. In some embodiments, the project implementation model comprises one or more layers. For example, the project implementation model may comprise a first layer configured to generate a responsive resource allocation unit. As another example, the project implementation model may comprise a second layer configured to generate a project implementation electronic record.

In some embodiments, the cloud-based project operations device 140 is configured to train the project implementation model. In some embodiments, the cloud-based project operations device 140 is configured to train the project implementation model based on an archived requirement feature. Additionally, or alternatively, the cloud-based project operations device 140 is configured to train the project implementation model based on an archived responsive resource allocation unit. Additionally, or alternatively, the cloud-based project operations device 140 is configured to train the project implementation model based on an archived project implementation electronic record. In this regard, in some embodiments, requirement features, responsive resource allocation units, and/or project implementation electronic records previously accessed and/or generated by the cloud-based project operations device 140 may be able to be used by the cloud-based project operations device 140 to continually improve the project implementation model.

As shown in block 704, the method 700 may comprise determining, using the project implementation model, a physical component object corresponding to the requirement feature.

As described above, in some embodiments, the cloud-based project operations device 140 is configured to generate a responsive resource allocation unit by applying a requirement feature to a project implementation model. In this regard, in some embodiments, generating a responsive resource allocation unit comprises the cloud-based project operations device 140 being configured to, using the project implementation model, determine a physical component object representative of a physical component that satisfies a requirement feature associated with a requirement electronic record accessed by the cloud-based project operations device 140. In some embodiments, the project implementation model is configured to determine a physical component object representative of a physical component that satisfies a requirement feature associated with a requirement electronic record accessed by the cloud-based project operations device 140 by performing at least one electronic filtering operations of a set of electronic filtering operations. In this regard, in some embodiments, the cloud-based project operations device 140 is configured to perform at least one electronic filtering operation to identify a physical component object representative of a physical component that satisfies a requirement feature associated with a requirement electronic record accessed by the cloud-based project operations device 140 from a set of physical component objects.

In some embodiments, the set of electronic filtering operations comprises a text-based filtering operation. In some embodiments, a text-based filtering operation comprises identifying a first sequence of characters from a requirement electronic record using an optical character recognition (OCR) technique. In some embodiments, a text-based filtering operation comprises identifying one or more other sequences of characters from a set of physical component objects using an optical character recognition (OCR) technique. In some embodiments, a text-based filtering operation comprises comparing the first sequence of characters with one or more of the one or more other sequences of characters. In this regard, for example, the cloud-based project operations device 140 may identify a physical component object representative of a physical component that satisfies a requirement feature associated with a requirement electronic record by finding a match between the first sequence of characters and the one or more of the one or more other sequences of characters.

In some embodiments, the cloud-based project operations device 140 may leverage the project extraction predictive computing entity 226 to execute an optical character recognition (OCR) technique (e.g., the project extraction predictive computing entity 226 may be configured to perform an optical character recognition (OCR) technique). In some embodiments, the set of electronic filtering operations comprises a geometry-based filtering operation. In some embodiments, a geometry-based filtering operation comprises identifying a geometric element from a requirement electronic record. In some embodiments, a geometry-based filtering operation comprises identifying one or more other geometric elements from a set of physical component objects. In some embodiments, a geometry-based filtering operation comprises comparing the geometric element with one or more of the one or more other geometric elements. In this regard, for example, the cloud-based project operations device 140 may identify a physical component object representative of a physical component that satisfies a requirement feature associated with a requirement electronic record by finding a match between the geometric element and the one or more of the one or more other geometric elements.

In some embodiments, the set of electronic filtering operations comprises a design-based filtering operation. In some embodiments, a design-based filtering operation comprises identifying a data encoding from a requirement electronic record. For example, a data encoding may comprises one or more of an svg, .dwg, .tiff, .png, .obj, .amf, .stl, and/or .glb data encoding. In some embodiments, a design-based filtering operation comprises identifying one or more other data encodings from a set of physical component objects. In some embodiments, a design-based filtering operation comprises comparing the data encoding with one or more of the one or more other data encodings. In this regard, for example, the cloud-based project operations device 140 may identify a physical component object representative of a physical component that satisfies a requirement feature associated with a requirement electronic record by finding a match between the data encoding and the one or more of the one or more other data encodings.

In some embodiments, the set of electronic filtering operations comprises a sketch-based filtering operation. In some embodiments, a sketch-based filtering operation comprises identifying a sketch feature from a requirement electronic record. For example, a sketch feature may be representative of a feature of a sketch or 3D model. In some embodiments, a sketch-based filtering operation comprises identifying one or more other sketch features from a set of physical component objects. In some embodiments, a sketch-based filtering operation comprises comparing the sketch feature with one or more of the one or more other sketch features. In this regard, for example, the cloud-based project operations device 140 may identify a physical component object representative of a physical component that satisfies a requirement feature associated with a requirement electronic record by finding a match between the sketch feature and the one or more of the one or more other sketch features.

In some embodiments, the set of electronic filtering operations comprises a topology-based filtering operation. In some embodiments, a topology-based filtering operation comprises identifying a topology feature from a requirement electronic record. For example, topology feature may be data representative of a component configuration, architecture indicating connections between several components, and/or an organization of information in an electronic record. In some embodiments, a topology-based filtering operation comprises identifying one or more other topology features from a set of physical component objects. In some embodiments, a topology-based filtering operation comprises comparing the topology feature with one or more of the one or more other topology features. In this regard, for example, the cloud-based project operations device 140 may identify a physical component object representative of a physical component that satisfies a requirement feature associated with a requirement electronic record by finding a match between the topology feature and the one or more of the one or more other topology features.

In some embodiments, the set of electronic filtering operations comprises a color-based filtering operation. In some embodiments, a color-based filtering operation comprises identifying first pixel data from a requirement electronic record. In some embodiments, a color-based filtering operation comprises identifying other pixel data from a set of physical component objects. For example, first pixel data and/or other pixel data may be representative of colors, color usage patterns, and/or color coordinates in an electronic record. In some embodiments, a color-based filtering operation comprises comparing the first pixel data with the other pixel data. In this regard, for example, the cloud-based project operations device 140 may identify a physical component object representative of a physical component that satisfies a requirement feature associated with a requirement electronic record by finding a match between the first pixel data and the other pixel data.

As shown in block 706, the method 700 may comprise determining, using the project implementation model, a physical component implementation unit based on the physical component object.

As described above, in some embodiments, generating a responsive allocation unit comprises the cloud-based project operations device 140 being configured to, using the project implementation model, determine a physical component implementation unit corresponding to a physical component object that satisfies a requirement feature associated with a requirement electronic record accessed by the cloud-based project operations device 140. In this regard, in some embodiments, the project implementation model may be configured to determine the resources needed to design, engineer, test, implement, configure, and/or acquire one or more physical components that have been identified by the project implementation model by performing at least one electronic filtering operations of a set of electronic filtering operations.

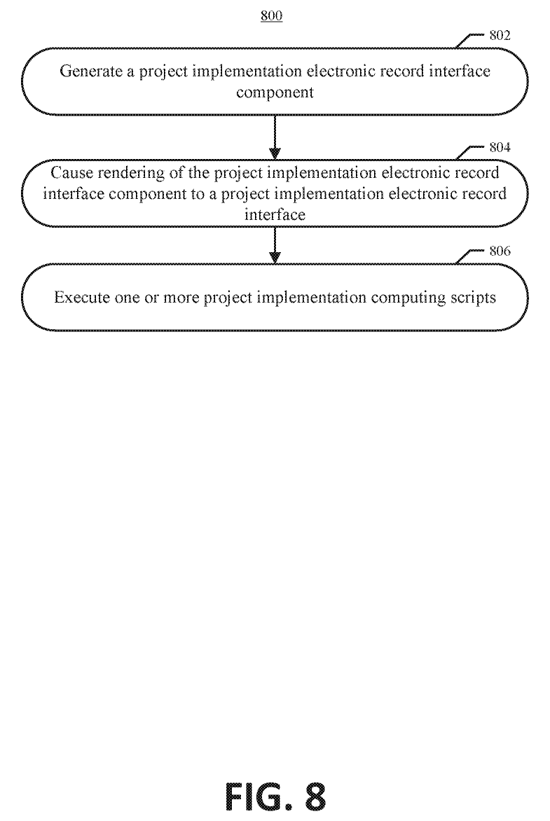

Referring now to FIG. 8, a flowchart providing an example method 800 is illustrated. In this regard, FIG. 8 illustrates operations that may be performed by the project foundation device 180, the external project implementation device 120, the external project application device 110, the cloud-based project operations device 140, the one or more databases 150, and/or the user device 170. In some embodiments, the method 800 comprises operations for performing one or more project implementation actions based on the project implementation electronic record. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800.

As shown in block 802, the method 800 may comprise generating a project implementation electronic record interface component. In some embodiments, the project implementation electronic record interface component comprises a project implementation electronic record representation.

As described above, in some embodiments, performing one or more project implementation actions comprises the cloud-based project operations device 140 being configured to generate a project implementation electronic record interface component 402. In some embodiments, the project implementation electronic record interface component 402 is configured to display a project implementation electronic record representation 404 that is representative of one or more project implementation electronic records. For example, the project implementation electronic record representation 404 may be a representation of a project implementation electronic record that comprises a plan for implementing the proposed project corresponding to a requirement electronic record based on a set of free resource unit objects.

As shown in block 804, the method 800 may comprise causing rendering of the project implementation electronic record interface component to a project implementation electronic record interface.

As described above, in some embodiments, performing one or more project implementation actions comprises the cloud-based project operations device 140 being configured to cause a project implementation electronic record interface component 402 to be rendered to project implementation electronic record interface 400. In some embodiments, the project implementation electronic record interface 400 may be provided on a display associated with the cloud-based project operations device 140 and/or a display associated with the project foundation device 180.

As shown in block 806, the method 800 may comprise executing one or more project implementation computing scripts.

As described above, in some embodiments, performing one or more project implementation actions comprises the cloud-based project operations device 140 being configured to execute one or more project implementation computing scripts. In this regard, in some embodiments, the one or more project implementation computing scripts comprise executable code configured to cause execution of at least a portion of a plan, design, and/or process for implementing a project. In some embodiments, execution of one or more project implementation computing scripts comprises executing code that causes procurement of physical components and/or resources associated with a project implementation electronic record. In some embodiments, execution of one or more project implementation computing scripts comprises executing code that causes allocation of physical components and/or resources associated with a project implementation electronic record associated with a project implementation electronic record to a project. In some embodiments, execution of one or more project implementation computing scripts comprises executing code that causes actuation of a device that manufactures a physical component associated with a project implementation electronic record (e.g., to turn on, create the physical component, and/or to shut down). In some embodiments, execution of one or more project implementation computing scripts comprises executing code that causes generation of a physical component associated with a project implementation electronic record delegation of project tasks to one or more third party manufacturers. In some embodiments, execution of one or more project implementation computing scripts comprises executing code that causes initiation of a relocation of physical components and/or resources associated with a project implementation electronic record to a new geographic location. In some embodiments, causes removal from a project of physical components and/or resources associated with a project implementation electronic record. In some embodiments, execution of one or more project implementation computing scripts comprises executing code that causes reassignment of physical components and/or resources associated with a different project to a project associated with a project implementation electronic record. In some embodiments, execution of one or more project implementation computing scripts comprises executing code that generates a proposed project quote. In some embodiments, execution of one or more project implementation computing scripts comprises executing code that causes generation of a proposed project timeline.

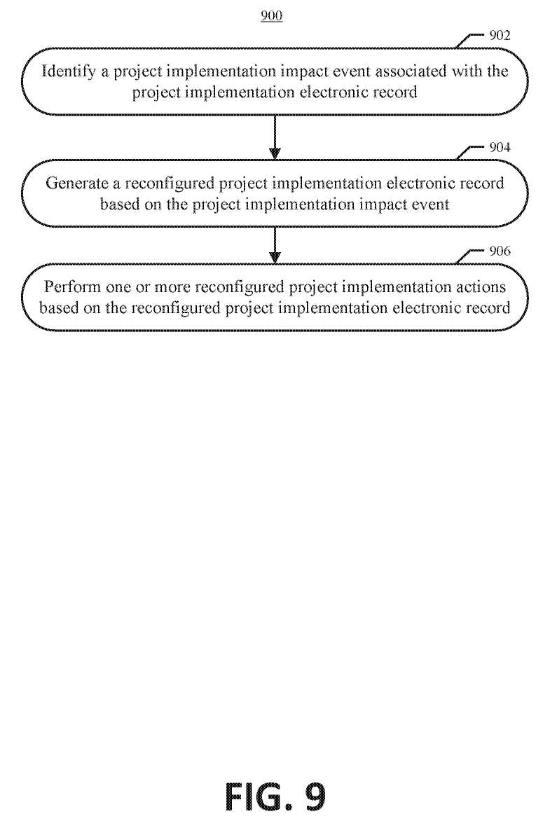

Referring now to FIG. 9, a flowchart providing an example method 900 is illustrated. In this regard, FIG. 9 illustrates operations that may be performed by the project foundation device 180, the external project implementation device 120, the external project application device 110, the cloud-based project operations device 140, the one or more databases 150, and/or the user device 170. In some embodiments, the method 900 comprises operations for generating a reconfigured project implementation electronic record based on a project implementation impact event. In some embodiments, the example method 900 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 900.

As shown in block 902, the method 900 may comprise identifying a project implementation impact event associated with the project implementation electronic record.

As described above, in some embodiments, the cloud-based project operations device 140 is configured to identify a project implementation impact event associated with a project implementation electronic record. In some embodiments, the one or more project implementation actions may be performed prior to identifying the project implementation impact event. In some embodiments, a project implementation impact event is any occurrence that causes a change to the responsive resource allocation unit associated with a project implementation electronic record. In this regard, in some embodiments, a project implementation impact event may comprise a change to the requirement electronic record, a change to one or more requirement features, and/or the like. In some embodiments, a project implementation impact event is any occurrence that causes a change to a free resource unit object associated with a project implementation electronic record. In some embodiments, identifying a project implementation impact event comprises the cloud-based project operations device 140 being configured to receive the project implementation impact event from external project application device 110. In some embodiments, identifying a project implementation impact event comprises the cloud-based project operations device 140 being configured to receive the project implementation impact event from project foundation device 180.

As shown in block 904, the method 900 may comprise generating a reconfigured project implementation electronic record based on the project implementation impact event.

As described above, in some embodiments, the cloud-based project operations device 140 is configured to generate a reconfigured project implementation electronic record (e.g., using the project operations predictive computing entity 220). In some embodiments, the cloud-based project operations device 140 to generate a reconfigured project implementation electronic record based on a project implementation impact event. For example, the cloud-based project operations device 140 may be configured to generate a reconfigured project implementation electronic record based on a project implementation impact event that includes a change to a requirement electronic record, a change to one or more requirement features, and/or the like. As another example, the cloud-based project operations device 140 may be configured to generate a reconfigured project implementation electronic record based on a project implementation impact event that includes a change to a free resource unit object associated with a project implementation electronic record. Said differently, for example, the cloud-based project operations device 140 is configured to generate a reconfigured project implementation electronic record that factors in the reconfigured project implementation electronic record by using a similar process as described above with respect to generating a project implementation electronic record.

As shown in block 906, the method 900 may comprise performing one or more reconfigured project implementation actions based on the reconfigured project implementation electronic record.

As described above, in some embodiments, the cloud-based project operations device 140 is configured to perform one or more reconfigured project implementation actions. For example, the cloud-based project operations device 140 is configured to perform one or more reconfigured project implementation actions using the project orchestration predictive computing entity 204. In some embodiments, the cloud-based project operations device 140 is configured to perform one or more reconfigured project implementation actions based on the reconfigured project implementation electronic record. In this regard, for example, the cloud-based project operations device 140 may be configured to perform one or more reconfigured project implementation actions in order to execute, implement, and/or the like a plan, design, and/or process for implementing a project using a set of free resource unit objects.

In some embodiments, performing one or more reconfigured project implementation actions comprises the cloud-based project operations device 140 being configured to generate a reconfigured project implementation electronic record interface component 502. In some embodiments, the reconfigured project implementation electronic record interface component 502 is configured to display a reconfigured project implementation electronic record representation 504 that is representative of one or more reconfigured project implementation electronic records. For example, the reconfigured project implementation electronic record representation 504 may be a representation of a reconfigured project implementation electronic record that comprises a reconfigured plan for implementing the proposed project corresponding to a requirement electronic record based on a set of free resource unit objects and the project implementation impact event.

In some embodiments, performing one or more reconfigured project implementation actions comprises the cloud-based project operations device 140 being configured to cause a reconfigured project implementation electronic record interface component 502 to be rendered to project implementation electronic record interface 400. In some embodiments, the project implementation electronic record interface 400 may be provided on a display associated with the cloud-based project operations device 140 and/or a display associated with the project foundation device 180.

In some embodiments, performing one or more reconfigured project implementation actions comprises the cloud-based project operations device 140 being configured to execute one or more reconfigured project implementation computing scripts. In this regard, in some embodiments, the one or more reconfigured project implementation computing scripts comprise executable code configured to cause execution of at least a portion of a plan, design, and/or process for implementing a project. In some embodiments, execution of one or more reconfigured project implementation computing scripts comprises executing code that causes procurement of physical components and/or resources associated with a reconfigured project implementation electronic record. In some embodiments, execution of one or more reconfigured project implementation computing scripts comprises executing code that causes generation of a project delay prediction. In some embodiments, execution of one or more reconfigured project implementation computing scripts comprises executing code that causes generation of a supply chain delay prediction. In some embodiments, execution of one or more reconfigured project implementation computing scripts comprises executing code that causes generation of an alternative physical component supplier recommendation. In some embodiments, execution of one or more reconfigured project implementation computing scripts comprises executing code that causes generation of a project proposal success rate estimation. In some embodiments, execution of one or more reconfigured project implementation computing scripts comprises executing code that causes generation of a reconfigured impact value estimation. In some embodiments, execution of one or more reconfigured project implementation computing scripts comprises executing code that causes generation of a reconfigured impact result estimation. In some embodiments, execution of one or more reconfigured project implementation computing scripts comprises executing code that causes procurement of one or more physical components. In some embodiments, execution of one or more reconfigured project implementation computing scripts comprises executing code that causes allocation of one or more resources to a project or proposed project.

In some embodiments, execution of one or more reconfigured project implementation computing scripts comprises executing code that causes actuation of a device to manufacture a physical component. In some embodiments, execution of one or more reconfigured project implementation computing scripts comprises executing code that causes delegation of project tasks to members of a workforce. In some embodiments, execution of one or more reconfigured project implementation computing scripts comprises executing code that causes delegation of project tasks to one or more third party contractors. In some embodiments, execution of one or more reconfigured project implementation computing scripts comprises executing code that causes initiation of a relocation of physical components and/or resources associated with a reconfigured project implementation electronic record to a new geographic location. In some embodiments, causes removal from a project of physical components and/or resources associated with a reconfigured project implementation electronic record. In some embodiments, execution of one or more reconfigured project implementation computing scripts comprises executing code that causes reassignment of physical components and/or resources associated with a different project to a project associated with a reconfigured project implementation electronic record. In some embodiments, execution of one or more reconfigured project implementation computing scripts comprises executing code that generates a proposed project quote. In some embodiments, execution of one or more project implementation computing scripts comprises executing code that causes generation of a proposed project timeline.

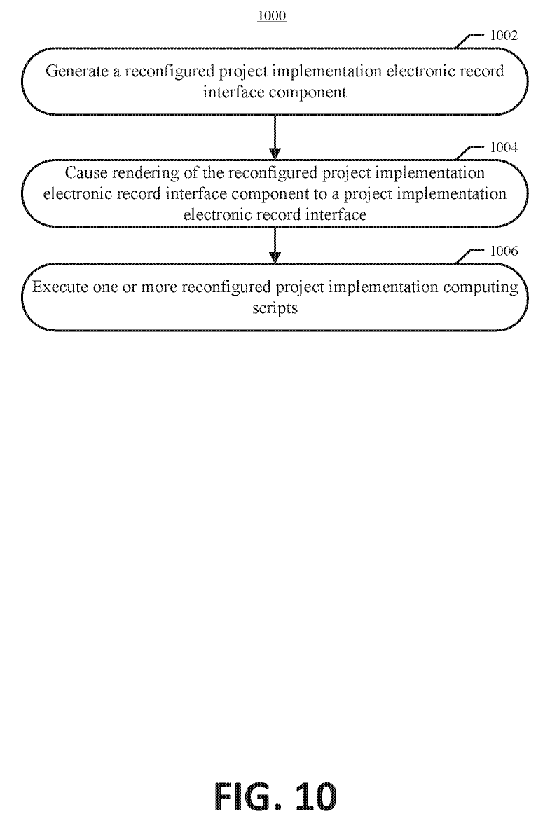

Referring now to FIG. 10, a flowchart providing an example method 1000 is illustrated. In this regard, FIG. 10 illustrates operations that may be performed by the project foundation device 180, the external project implementation device 120, the external project application device 110, the cloud-based project operations device 140, the one or more databases 150, and/or the user device 170. In some embodiments, the method 1000 comprises operations for performing one or more reconfigured project implementation actions based on a reconfigured project implementation electronic record. In some embodiments, the example method 1000 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1000.

As shown in block 1002, the method 1000 may comprise generating a reconfigured project implementation electronic record interface component. In some embodiments, the reconfigured project implementation electronic record interface component comprises a reconfigured project implementation electronic record representation.

As described above, in some embodiments, performing one or more reconfigured project implementation actions comprises the cloud-based project operations device 140 being configured to generate a reconfigured project implementation electronic record interface component 502. In some embodiments, the reconfigured project implementation electronic record interface component 502 is configured to display a reconfigured project implementation electronic record representation 504 that is representative of one or more reconfigured project implementation electronic records. For example, the reconfigured project implementation electronic record representation 504 may be a representation of a reconfigured project implementation electronic record that comprises a reconfigured plan for implementing the proposed project corresponding to a requirement electronic record based on a set of free resource unit objects and the project implementation impact event.

As shown in block 1004, the method 1000 may comprise causing rendering of the reconfigured project implementation electronic record interface component to a project implementation electronic record interface.

As described above, in some embodiments, performing one or more reconfigured project implementation actions comprises the cloud-based project operations device 140 being configured to cause a reconfigured project implementation electronic record interface component 502 to be rendered to project implementation electronic record interface 400. In some embodiments, the project implementation electronic record interface 400 may be provided on a display associated with the cloud-based project operations device 140 and/or a display associated with the project foundation device 180.

As shown in block 1006, the method 1000 may comprise executing one or more reconfigured project implementation computing scripts.

As described above, in some embodiments, performing one or more reconfigured project implementation actions comprises the cloud-based project operations device 140 being configured to execute one or more reconfigured project implementation computing scripts. In this regard, in some embodiments, the one or more reconfigured project implementation computing scripts comprise executable code configured to cause execution of at least a portion of a plan, design, and/or process for implementing a project. In some embodiments, execution of one or more reconfigured project implementation computing scripts comprises executing code that causes procurement of physical components and/or resources associated with a reconfigured project implementation electronic record. In some embodiments, execution of one or more reconfigured project implementation computing scripts comprises executing code that causes generation of a project delay prediction. In some embodiments, execution of one or more reconfigured project implementation computing scripts comprises executing code that causes generation of a supply chain delay prediction. In some embodiments, execution of one or more reconfigured project implementation computing scripts comprises executing code that causes generation of an alternative physical component supplier recommendation. In some embodiments, execution of one or more reconfigured project implementation computing scripts comprises executing code that causes generation of a project proposal success rate estimation. In some embodiments, execution of one or more reconfigured project implementation computing scripts comprises executing code that causes generation of a reconfigured impact value estimation. In some embodiments, execution of one or more reconfigured project implementation computing scripts comprises executing code that causes generation of a reconfigured impact result estimation. In some embodiments, execution of one or more reconfigured project implementation computing scripts comprises executing code that causes procurement of one or more physical components. In some embodiments, execution of one or more reconfigured project implementation computing scripts comprises executing code that causes allocation of one or more resources to a project or proposed project. In some embodiments, execution of one or more reconfigured project implementation computing scripts comprises executing code that causes actuation of a device to manufacture a physical component. In some embodiments, execution of one or more reconfigured project implementation computing scripts comprises executing code that causes delegation of project tasks to members of a workforce. In some embodiments, execution of one or more reconfigured project implementation computing scripts comprises executing code that causes delegation of project tasks to one or more third party contractors. In some embodiments, execution of one or more project implementation computing scripts comprises executing code that causes initiation of a relocation of physical components and/or resources associated with a project implementation electronic record to a new geographic location. In some embodiments, causes removal from a project of physical components and/or resources associated with a project implementation electronic record. In some embodiments, execution of one or more project implementation computing scripts comprises executing code that causes reassignment of physical components and/or resources associated with a different project to a project associated with a project implementation electronic record. In some embodiments, execution of one or more project implementation computing scripts comprises executing code that generates a proposed project quote. In some embodiments, execution of one or more project implementation computing scripts comprises executing code that causes generation of a proposed project timeline.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
accessing, at a project orchestration predictive computing entity, a requirement electronic record, wherein the requirement electronic record comprises a requirement feature;
generating, using a project operations predictive computing entity, a responsive resource allocation unit by applying the requirement feature to a project implementation model;
extracting, using the project operations predictive computing entity, a set of free resource unit objects from a plurality of resource unit objects based on the responsive resource allocation unit;
generating, using the project operations predictive computing entity, a project implementation electronic record by applying the set of free resource unit objects to the project implementation model; and
performing, using the project orchestration predictive computing entity, one or more project implementation actions based on the project implementation electronic record.

2. The method of claim 1, wherein generating the responsive resource allocation unit comprises:
determining, using the project implementation model, a physical component object corresponding to the requirement feature; and
determining, using the project implementation model, a physical component implementation unit based on the physical component object.

3. The method of claim 1, further comprising:
training the project implementation model based on an archived requirement feature and an archived responsive resource allocation unit.

4. The method of claim 1, wherein performing the one or more project implementation actions comprises:
generating a project implementation electronic record interface component, wherein the project implementation electronic record interface component comprises a project implementation electronic record representation; and
causing rendering of the project implementation electronic record interface component to a project implementation electronic record interface.

5. The method of claim 1, wherein performing the one or more project implementation actions comprises:
executing one or more project implementation computing scripts.

6. The method of claim 1, further comprising:
identifying a project implementation impact event associated with the project implementation electronic record;
generating a reconfigured project implementation electronic record based on the project implementation impact event; and
performing one or more reconfigured project implementation actions based on the reconfigured project implementation electronic record.

7. The method of claim 6, wherein identifying the project implementation impact event comprises receiving the project implementation impact event from an external project application device or a project foundation device.

8. The method of claim 6, wherein at least one of the one or more project implementation actions is performed prior to identifying the project implementation impact event.

9. The method of claim 6, wherein performing the one or more reconfigured project implementation actions comprises:
generating a reconfigured project implementation electronic record interface component, wherein the reconfigured project implementation electronic record interface component comprises a reconfigured project implementation electronic record representation; and
causing rendering of the reconfigured project implementation electronic record interface component to a project implementation electronic record interface.

10. The method of claim 6, wherein performing the one or more reconfigured project implementation actions comprises:
executing one or more reconfigured project implementation computing scripts.

11. An apparatus comprising memory and one or more processors communicatively coupled to the memory, the one or more processors configured to perform operations comprising:
accessing, at a project orchestration predictive computing entity, a requirement electronic record, wherein the requirement electronic record comprises a requirement feature;
generating, using a project operations predictive computing entity, a responsive resource allocation unit by applying the requirement feature to a project implementation model;
extracting, using the project operations predictive computing entity, a set of free resource unit objects from a plurality of resource unit objects based on the responsive resource allocation unit;
generating, using the project operations predictive computing entity, a project implementation electronic record by applying the set of free resource unit objects to the project implementation model; and
performing, using the project orchestration predictive computing entity, one or more project implementation actions based on the project implementation electronic record.

12. The apparatus of claim 11, wherein generating the responsive resource allocation unit comprises:
determining, using the project implementation model, a physical component object corresponding to the requirement feature; and
determining, using the project implementation model, a physical component implementation unit based on the physical component object.

13. The apparatus of claim 11, wherein the one or more processors are further configured to perform operations comprising:
training the project implementation model based on an archived requirement feature and an archived responsive resource allocation unit.

14. The apparatus of claim 11, wherein performing the one or more project implementation actions comprises:
executing one or more project implementation computing scripts.

15. The apparatus of claim 11, wherein the one or more processors are further configured to perform operations comprising:
identifying a project implementation impact event associated with the project implementation electronic record;
generating a reconfigured project implementation electronic record based on the project implementation impact event; and
performing one or more reconfigured project implementation actions based on the reconfigured project implementation electronic record.

16. The apparatus of claim 15, wherein performing the one or more reconfigured project implementation actions comprises:
executing one or more reconfigured project implementation computing scripts.

17. A computer program product comprising at least one non-transitory computer-readable storage medium having computer program code stored thereon that, in execution with at least one processor, configures the computer program product for:
accessing, at a project orchestration predictive computing entity, a requirement electronic record, wherein the requirement electronic record comprises a requirement feature;
generating, using a project operations predictive computing entity, a responsive resource allocation unit by applying the requirement feature to a project implementation model;
extracting, using the project operations predictive computing entity, a set of free resource unit objects from a plurality of resource unit objects based on the responsive resource allocation unit;
generating, using the project operations predictive computing entity, a project implementation electronic record by applying the set of free resource unit objects to the project implementation model; and
performing, using the project orchestration predictive computing entity, one or more project implementation actions based on the project implementation electronic record.

18. The computer program product of claim 17, wherein performing the one or more project implementation actions comprises:
executing one or more project implementation computing scripts.

19. The computer program product of claim 17, wherein computer program code, in execution with at least one processor, further configures the computer program product for:
identifying a project implementation impact event associated with the project implementation electronic record;
generating a reconfigured project implementation electronic record based on the project implementation impact event; and
performing one or more reconfigured project implementation actions based on the reconfigured project implementation electronic record.

20. The computer program product of claim 19, wherein performing the one or more reconfigured project implementation actions comprises:
executing one or more reconfigured project implementation computing scripts.
